(19) United States
(12) Patent Application Publication
(10) Pub. No.: US 2023/0118018 A1
(43) Pub. Date: Apr. 20, 2023

(54) WIRELESS DATA TRANSMISSIONS USING PARITY BLOCKS

(71) Applicant: ZTE Corporation, Shenzhen (CN)

(72) Inventors: Qiujin Guo, Shenzhen (CN); Jin Xu, Shenzhen (CN); Liguang Li, Shenzhen (CN); Chulong Liang, Shenzhen (CN); Qiang Fu, Shenzhen (CN); Jian Kang, Shenzhen (CN)

(21) Appl. No.: 18/066,543

(22) Filed: Dec. 15, 2022

Related U.S. Application Data
(63) Continuation of application No. PCT/CN2020/096310, filed on Jun. 16, 2020.

(30) Foreign Application Priority Data
Jun. 15, 2020 (WO) PCT/CN2020/096098

(51) Int. Cl. H04W 28/04; H04L 1/00

(52) U.S. Cl. CPC H04W 28/04; H04L 1/0068; H04L 1/0061

(57) ABSTRACT

Methods, systems and apparatus for wireless communication are described. One example method of wireless communication includes receiving, by a wireless device from a network device, a first message comprising one or more parameters related to an error correction coding, and transmitting, by the wireless device to the network device, a data transmission using the error correction coding according to the one or more parameters.

### CROSS REFERENCE TO RELATED APPLICATIONS

This patent document is a continuation of and claims benefit of priority to International Patent Application No. PCT/CN2020/096310, filed on Jun. 16, 2020, which is a continuation of International Patent Application No. PCT/CN2020/096098, filed on Jun. 15, 2020. The entire content of the before-mentioned patent applications is incorporated by reference as part of the disclosure of this application.

### TECHNICAL FIELD

This document is directed generally to wireless communications.

### BACKGROUND

Wireless communication technologies are moving the world toward an increasingly connected and networked society. The rapid growth of wireless communications and advances in technology has led to greater demand for capacity and connectivity. Other aspects, such as energy consumption, device cost, spectral efficiency, and latency are also important to meet the needs of various communication scenarios. In comparison with the existing wireless networks, such as LTE wireless networks, next generation systems and wireless communication techniques need to provide support for an increased number of users and devices.

### SUMMARY

This document relates to methods, systems, and devices for monitoring schemes for downlink control signals in mobile communication technology, including 5th Generation (5G) and New Radio (NR) communication systems.

In one exemplary aspect, a wireless communication method is disclosed. The method includes receiving, by a wireless device from a network device, a first message comprising one or more parameters related to an error correction coding, and transmitting, by the wireless device to the network device, a data transmission using the error correction coding according to the one or more parameters.

In another exemplary aspect, a wireless communication method is disclosed. The method includes transmitting, by a network device to a wireless device, a first message comprising one or more parameters related to an error correction coding; and transmitting, after the transmitting the first message, by the network device to the wireless device, a data transmission using the error correction coding according to the one or more parameters.

In another exemplary aspect, a wireless communication method is disclosed. The method includes receiving, by a wireless device from a network device, a first message comprising one or more parameters related to an error correction coding; and receiving, by the wireless device from the network device, a data transmission using the error correction coding according to the one or more parameters.

In another exemplary aspect, a wireless communication method is disclosed. The method includes transmitting, by a network device to a wireless device, a first message comprising one or more parameters related to an error correction coding; and receiving, after the transmitting the first message, by the network device from the wireless device, a data transmission using the error correction coding according to the one or more parameters.

In another exemplary aspect, a wireless communication method is disclosed. The method includes generating, by a first wireless device, from data bits to be transmitted, plurality of code blocks, including at least one redundancy parity block; dividing the plurality of code blocks into at least a first group of code blocks and a second group of code blocks according to permitted puncturing bit locations; rate matching the code blocks by puncturing according the permitted puncturing bit locations; and transmitting a result of the rate matching to a second wireless device.

In another exemplary aspect, a wireless communication method is disclosed. The method includes receiving, by a first wireless device, a data transmission comprising rate matched data, wherein the rate matched data is generated by dividing a plurality of code blocks including at least one redundancy parity block into a first group of code blocks and a second group of code blocks according to permitted puncturing locations and puncturing the code blocks of the first group and the second group according to the permitted puncturing locations; and determining, from the data transmission, data bits encoded in the data transmission.

In another exemplary aspect, a wireless communication method is disclosed. The method includes generating, by a first wireless device, from data bits to be transmitted, a plurality of code blocks, including at least one redundancy parity block; dividing the plurality of code blocks into at least a first group of code blocks and a second group of code blocks according to permitted puncturing locations; rate matching the plurality of code blocks by puncturing according to a puncturing pattern, wherein the puncturing pattern defines locations of bits permitted to be punctured for each code block in the plurality of code blocks; and transmitting a result of the rate matching to a second wireless device.

In another exemplary aspect, a wireless communication method is disclosed. The method includes receiving, by a first wireless device, a data transmission comprising a plurality of code blocks including at least one redundancy parity block, wherein the plurality of code blocks is rate matched according to a puncturing pattern that defines locations of bits permitted to be punctured for each code block in the plurality of code blocks; and determining, based on the puncturing pattern, data bits encoded in the data transmission.

In yet another exemplary aspect, the above-described methods are embodied in the form of processor-executable code and stored in a computer-readable program medium.

In yet another exemplary embodiment, a device that is configured or operable to perform the above-described methods is disclosed.

The above and other aspects and their implementations are described in greater detail in the drawings, the descriptions, and the claims.

### BRIEF DESCRIPTION OF THE DRAWINGS

FIG. 1 illustrates an example of a base station (BS) and user equipment (UE) in wireless communication.

FIG. 2 illustrates an example of rate matching of one of a plurality of code blocks.

FIG. 3 illustrates low density parity check- (LDPC) based inter-code block parity bits generated by an all ones generation sequence and modulo 2 operation.

FIG. 4 illustrates a procedure of a downlink control information (DCI) indicating from a validation of a redundancy parity bits scheduling to a release of a redundancy parity bits scheduling.

FIGS. 5A and 5B illustrate a same puncturing bit-location for each code block in one group.

FIG. 6 illustrates puncturing bit-locations between code blocks in different groups including redundancy parity blocks that are not overlapped.

FIGS. 7A and 7B illustrate puncturing bit-locations for all code blocks including redundancy parity blocks that are not overlapped.

FIG. 8 illustrates an elements distribution of a base graph 1 for a LDPC coding in a Fifth Generation (5G) New Radio (NR) communication system.

FIG. 9 illustrates an example of a punctured pattern for system code blocks for the base graph 1.

FIG. 10 illustrates an example of a punctured pattern for system code blocks for a base graph 2.

FIGS. 11A and 11B illustrate puncturing bit-locations for all code blocks including redundancy parity blocks that are not overlapped.

FIG. 12 illustrates an example of a process for wireless communication based on some example embodiments of the disclosed technology.

FIG. 13 illustrates another example of a process for wireless communication based on some example embodiments of the disclosed technology.

FIG. 14 illustrates another example of a process for wireless communication based on some example embodiments of the disclosed technology.

FIG. 15 illustrates another example of a process for wireless communication based on some example embodiments of the disclosed technology.

FIG. 16 illustrates another example of a process for wireless communication based on some example embodiments of the disclosed technology.

FIG. 17 illustrates another example of a process for wireless communication based on some example embodiments of the disclosed technology.

FIG. 18 illustrates another example of a process for wireless communication based on some example embodiments of the disclosed technology.

FIG. 19 illustrates another example of a process for wireless communication based on some example embodiments of the disclosed technology.

FIGS. 20A and 20B are flow charts for a downlink data transmission scheduling procedure including a redundancy parity block for a user equipment and gNodeB; FIGS. 20C and 20D are flow charts for an uplink data transmission scheduling procedure including a redundancy parity block for a user equipment and gNodeB.

FIGS. 21A and 21B are flow charts of a rate matching for data transmission including a redundancy parity block.

FIG. 22 is a block diagram representation of a portion of an apparatus that can be used to implement methods and/or techniques of the presently disclosed technology.

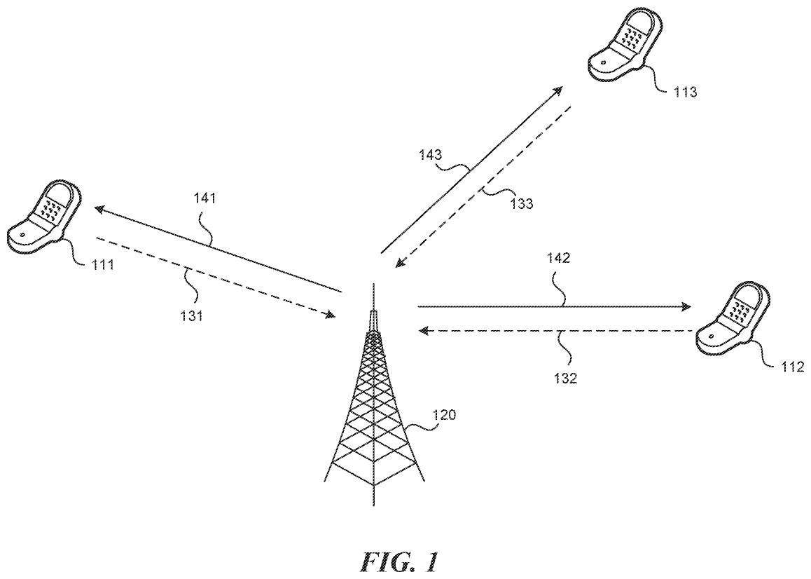

### DETAILED DESCRIPTION

Certain features are described using the example of Fifth Generation (5G) wireless protocol. However, applicability of the disclosed techniques is not limited to only 5G wireless systems.

In 5G and New Radio (NR) communication systems, there are three distinctive classes of use cases: enhanced mobile broadband (eMBB), massive machine type communication (mMTC) and ultra-reliable and low-latency communication (URLLC). Each use case corresponds to its own requirements for technology specifications. For example, enhanced Mobile Broadband (eMBB) aims to enable larger data volumes and support higher end-user data rates. For massive Machine Type Communications (mMTC), a high data rate is less important. Rather, it aims to support a massive number of devices with very low device costs and very low device energy consumption. For Ultra Reliable Low Latency Communications (URLLC), very low latency and extremely high reliability are required. Though these requirements are artificial, it is also available for further mobile communications, e.g., augmented reality/virtual reality (AR/VR) applications which require a higher peak data rate (e.g., 300 Mbps).

With the requirements of supporting higher data rates and extremely high reliability, it is hard to achieve the target high data rate and low error rate without a channel coding with good error correction performance and an effective decoding method. In 5G NR, low density parity check (LDPC) coding is used for data transmission in uplink/downlink (UL/DL) data channels. It is assumed that a target block error rate for LDPC coding is β and the error probability of each code block is independent. Therefore, for a transport block (TB) with a TB size (TBS) divided into n code blocks, the error probability of the whole TBS can be derived as 1−(1−β)ⁿ. A TBS error rate is increased with an increase in the number of code blocks, and reduced with a decrease in the target block error rate. Generally, the number of code blocks is increased with an increase of the TBS. Therefore, if the target block error rate can be reduced by an enhanced coding method, the requirements of enabling larger data volumes and extremely high reliability can be achieved.

In addition, from a power saving perspective, a higher frequency of re-transmissions of a TB may lead to a larger amount of power consumption. Therefore, it is useful to reduce the number of re-transmissions for TBs and improve reliability of each transmission in order to reduce power consumption.

Disclosed herein are techniques for controlling redundancy parity block transmissions, including scheduling, generating and transmitting an additional redundancy parity block, which are applied for an initial transmission or a re-transmission to improve reliability and reduce the number of re-transmissions.

The present document uses section headings and sub-headings for facilitating easy understanding and not for limiting the scope of the disclosed techniques and embodiments to certain sections. Accordingly, embodiments disclosed in different sections can be used with each other. Furthermore, the present document uses examples from the 3GPP NR network architecture and 5G protocol only to facilitate understanding and the disclosed techniques and embodiments may be practiced in other wireless systems that use communication protocols different from the 3GPP protocols.

### Brief Discussion

In 5G NR communication systems, there are a plurality of available modulation and coding scheme (MCS) tables for physical downlink shared channel (PDSCH) and physical uplink shared channel (PUSCH) providing user equipment (UE). The UE determines the TBS based on the parameters of the number of resource elements (N_{RE}), modulation order (Qₘ), code rate (R) and layer (v), which are obtained according to the resource allocation information configured by higher layer parameters or indicated by a downlink control information (DCI). The DCI transports downlink control information carried by physical downlink control channel (PDCCH) with the cyclic redundancy check (CRC) scrambled by a radio network temporary identifier (RNTI). Currently, there are 15 kinds of DCI formats, which are denoted as DCI format 0-0/1-0/0-1/1-1/0-2/1-2/2-0/2-1/2-2/2-3/2-4/2-5/2-6/3-0/3-1. Each DCI format can be used to indicate information for a specific usage. For example, the DCI format 1-1 is used for the scheduling of PDSCH in one cell and/or triggering one shot HARQ-ACK codebook feedback. The DCI bits for a same DCI format with different types of RNTI can have different usages and interpretations.

The information transmitted by means of a DCI format with CRC scrambled by a RNTI may be divided into a plurality of fields based on the usage or meaning of the information. For example, the ‘frequency domain resource assignment’ field in DCI format 1-1 with CRC scrambled by cell RNTI (C-RNTI) is used to indicate the frequency domain resource allocation for the scheduling data transmission. The fields defined in the DCI formats are mapped to the information bits a₀ to a_{A-1}. Each field is mapped in the order in which it appears in the description, including the zero-padding bit(s), if any, with the first field mapped to the lowest order information bit a₀ and each successive field mapped to higher order information bits. The most significant bit of each field is mapped to the lowest order information bit for that field. For example, the most significant bit of the first field is mapped to a₀.

One example implementation of an LDPC coding procedure is as follows:

1) Code block segmentation: Two base graphs, base graph 1 (BG1) and base graph 2 (BG2) for a NR-LDPC, used to obtain a check matrix. For example, the UE may select one of the two base graphs according to the rules shown in Table 1. For BG1, the maximum code block size is K_{cb}=8448, and for BG2, the maximum code block size is K_{cb}=3840. For a TB, the total number of bits after a CRC attachment is TBS+L_{TB_CRC}, where L_{TB_CRC}=24 bits. If the TBS+L_{TB_CRC} is not larger than K_{cb}, the number of the code block is 1, and the additional CRC sequence of L_{CB_CRC}=24 bits is not attached to the code block; otherwise, the total number of the code block is determined by C=ceil((TBS+L_{TB_CRC})/(K_{cb}−L_{CB_CRC})) The total number of bits of each code block is K′=(TBS+L_{TB_CRC}+C*L_{CB_CRC})/C.

TABLE 1
Base Graph Selection for NR-LDPC

| R | | 292 < | |
|---|---|---|---|
| TBS | ≤292 | K ≤ 3824 | >3824 |
| >2/3 | BG2 | BG1 | BG1 |
| 1/4 < R ≤ 2/3 | BG2 | BG2 | BG1 |
| ≤1/4 | BG2 | BG2 | BG2 |

2) Check matrix generation: the check matrix is determined by the base graph and a lifting size (Zc). The number of columns used for encoding system information bits is K_{b}=22Zc for BG1 and K_{b}=10Zc for BG2. The lifting size is the minimum value among a set of lifting sizes, as shown in Table 2, being satisfied with Zc≥K′/K_{b}. A base graph matrix H_{BG} is obtained based on the set index i_{LS} of Zc and the table of elements of each base graph corresponding to the set index, as shown in Table 3 and Table 4. After obtaining the base graph matrix H_{BG} and the value of Zc, a check matrix H is obtained by replacing each element of H_{BG} with a Zc*Zc matrix according to the following procedures:
each element of value 0 in H_{BG} is replaced by an all zero matrix of size Zc*Zc; and
each element of value 1 in H_{BG} is replaced by a circular permutation matrix I(P_{i,j}) of size Zc*Zc, where i and j are the row and column indices of the element, and I(P_{i,j}) is obtained by circularly shifting the identity matrix I of size Zc*Zc to the right Pᵢⱼ times. The value of P_{i,j} is given by P_{i,j}=mod(V_{i,j}, Zc). The value of V_{i,j} is given by the table of elements of the base graph according to the set index i_{LS} and LDPC base graph. For example, the base graph 1 for the NR-LDPC is shown in Table 3.

3) Encoding: After completing the above operations, the matrix H is used to encode the information bit sequence of each code block.

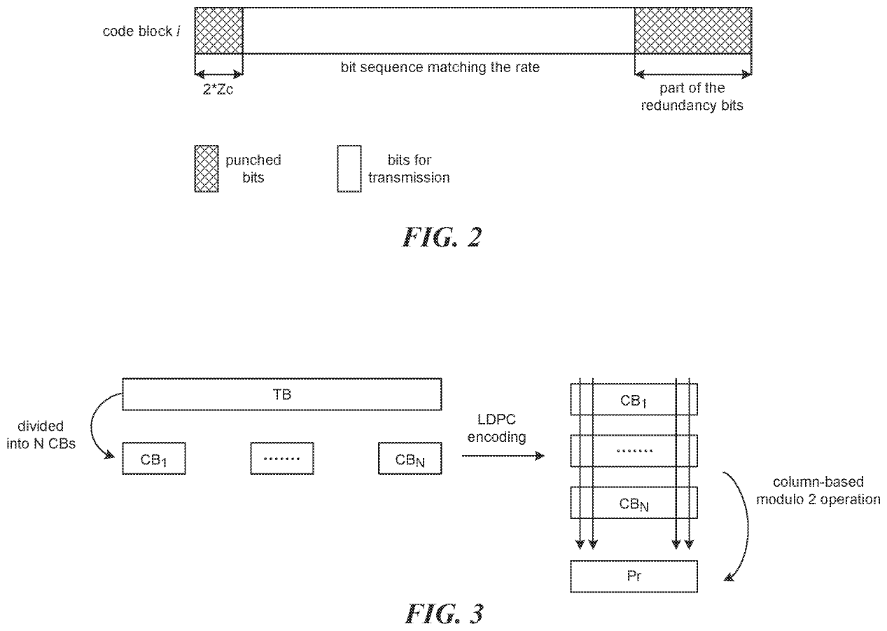

4) Rate matching and bit interleaving: after the encoding process, the encoded bit sequence of each code block is selected, and a part of the encoded bit sequence may be deleted to match the indicated code rate, as shown in FIG. 2. To further improve the error correction performance, the bit sequence is interleaved into a new bit sequence after rate matching. The resulting rate matched bit sequence is applied for modulating and generating a transmission waveform.

TABLE 2
Sets of LDPC lifting size Z

| Set index (i_{LS}) | Set of lifting sizes (Z) |
|---|---|
| 0 | {2, 4, 8, 16, 32, 64, 128, 256} |
| 1 | {3, 6, 12, 24, 48, 96, 192, 384} |
| 2 | {5, 10, 20, 40, 80, 160, 320} |
| 3 | {7, 14, 28, 56, 112, 224} |
| 4 | {9, 18, 36, 72, 144, 288} |
| 5 | {11, 22, 44, 88, 176, 352} |
| 6 | {13, 26, 52, 104, 208} |
| 7 | {15, 30, 60, 120, 240} |

TABLE 3
LDPC BG1 and its parity check matrices (V_{i, j})

| H_{BG} | | | | | | | | | |
|---|---|---|---|---|---|---|---|---|---|
| Row | Column | V_{i, j} | | | | | | | |
| index | index | Set index i_{LS} | | | | | | | |
| i | j | 0 | 1 | 2 | 3 | 4 | 5 | 6 | 7 |
| 0 | 0 | 250 | 307 | 73 | 223 | 211 | 294 | 0 | 135 |
| | . | . | . | . | . | . | . | . | . |
| | . | . | . | . | . | . | . | . | . |
| | . | . | . | . | . | . | . | . | . |
| | 23 | 0 | 0 | 0 | 0 | 0 | 0 | 0 | 0 |
| . | . | . | . | . | . | . | . | . | . |
| . | . | . | . | . | . | . | . | . | . |
| . | . | . | . | . | . | . | . | . | . |
| 15 | . | . | . | . | . | . | . | . | . |
| | . | . | . | . | . | . | . | . | . |
| | . | . | . | . | . | . | . | . | . |
| 15 | 1 | 96 | 2 | 290 | 120 | 0 | 348 | 6 | 138 |
| | . | . | . | . | . | . | . | . | . |
| | . | . | . | . | . | . | . | . | . |
| | . | . | . | . | . | . | . | . | . |
| | 37 | 0 | 0 | 0 | 0 | 0 | 0 | 0 | 0 |
| . | . | . | . | . | . | . | . | . | . |
| . | . | . | . | . | . | . | . | . | . |
| . | . | . | . | . | . | . | . | . | . |
| 45 | . | . | . | . | . | . | . | . | . |
| | . | . | . | . | . | . | . | . | . |
| | . | . | . | . | . | . | . | . | . |

TABLE 4
LDPC BG2 and its parity check matrices (V_{i, j})

| H_{BG} | | | | | | | | | |
|---|---|---|---|---|---|---|---|---|---|
| Row | Column | V_{i, j} | | | | | | | |
| index | index | Set index i_{LS} | | | | | | | |
| i | j | 0 | 1 | 2 | 3 | 4 | 5 | 6 | 7 |
| 0 | 0 | 9 | 174 | 0 | 72 | 3 | 156 | 143 | 145 |
| | . | . | . | . | . | . | . | . | . |
| | . | . | . | . | . | . | . | . | . |
| | . | . | . | . | . | . | . | . | . |
| | 11 | 0 | 0 | 0 | 0 | 0 | 0 | 0 | 0 |
| . | . | . | . | . | . | . | . | . | . |
| . | . | . | . | . | . | . | . | . | . |
| . | . | . | . | . | . | . | . | . | . |
| 16 | 1 | 203 | 87 | 0 | 75 | 48 | 78 | 125 | 170 |
| | . | . | . | . | . | . | . | . | . |
| | . | . | . | . | . | . | . | . | . |
| | . | . | . | . | . | . | . | . | . |
| 16 | 26 | 0 | 0 | 0 | 0 | 0 | 0 | 0 | 0 |
| . | . | . | . | . | . | . | . | . | . |
| . | . | . | . | . | . | . | . | . | . |
| . | . | . | . | . | . | . | . | . | . |
| . | . | . | . | . | . | . | . | . | . |
| . | . | . | . | . | . | . | . | . | . |
| . | . | . | . | . | . | . | . | . | . |
| . | . | . | . | . | . | . | . | . | . |
| . | . | . | . | . | . | . | . | . | . |
| . | . | . | . | . | . | . | . | . | . |
| 41 | . | . | . | . | . | . | . | . | . |
| | . | . | . | . | . | . | . | . | . |
| | . | . | . | . | . | . | . | . | . |

An encoded code block may include system bits and parity bits. The system bits are the original information bits which is a part of the TB. NR LDPC code is one example of the system code.

### Inter-Code Block Parity Bits Transmission Based on NR-LDPC

In some embodiments, the LDPC encoding process is to utilize parity check matrix H and the input bit sequence of each code block to generate codewords which are orthogonal to H. LDPC codes are linear block codes. For example, it is assumed that the size check matrix H is m x n and the encoded bit sequences of two code blocks with CBS=l are A=[a1, a2, . . . al]^{T}, and B=[b1, b2, . . . bl]^{T} respectively.

According to the characteristic of the check matrix for LDPC, it may be shown that H*A=0 and H*B=0. Hence, if A and B are added into C by a modulo 2 operation, H*C=0 can be derived by the equation of H*(A+B)=0. Therefore, the bit sequence C can be decoded and checked by matrix H and denoted as an encoded code block. Each bit of C is the sum of the corresponding bit of A and B by modulo 2 operation so that each bit of C can be used as the parity bit of the corresponding bits of A and B. That is to say, the bit sequence C can provide the A and B, which include the system information bits, with additional soft decoded information to improve the bit error correction performance of NR-LDPC. In general, for a transport block size (TBS) divided into multiple code blocks (e.g., CB₁, . . . , CB_{N}), the generation procedure of C by using all-ones generation sequence is shown in FIG. 3.

The transforming relationship between the system code blocks and the redundancy parity block may be defined as a generation sequence. For example, the generation sequence may be an all-ones sequence. In this case, the redundancy parity block Pr is obtained by (CB₁+CB₂+ . . . +CB_{N}) modulo 2. In addition, the generation sequence of the inter-code block parity block, which is denoted as the redundancy parity block Pr, can also be the other form other than the all-ones generation sequence. For example, for a re-transmission, there may be only few error code blocks so that the redundancy parity block can be generated by the error code blocks, e.g., CB2 and CB3 may have failed to be received among the total five code blocks, and the generation sequence should be [0 1 1 0 0]. Therefore, the redundancy parity block is obtained by (CB₂+CB₃).

However, for an initial transmission, some additional number of bits of each code block may be punctured to match with the target rate for the case of supporting redundancy parity block transmission. The redundancy parity bits transmission scheduling methods indicated by a layer 1 (L1) signaling (e.g., a DCI) are described in Embodiment Examples 1. The rate matching methods for redundancy parity block transmission are described in Embodiment Examples 2. The higher layer parameters related to redundancy parity block transmission are described in Embodiment 3.

In the following description, the code blocks which include the information bits of a TB are denoted as the system code blocks, and the additional code block obtained by the modulo 2 operation among code blocks is denoted as the redundancy parity block.

In some embodiments, the specific RNTI described as below can be used to scramble the CRC of a DCI and can be only associated with the redundancy parity bits transmission.

It may be noted that the various methods described herein can be used for both UL data transmission and DL data transmission procedures.

For a UL data transmission, the UE can first receive a downlink control signaling indicating a plurality of parameters transmitted by the gNodeB (gNB). The plurality of parameters can be related to scheduling UL data transmission. Next, the UE can transmit data to gNB based on the plurality of parameters. If the gNB does not receive the data transmitted by the UE corresponding to the downlink control signaling, the gNB can transmit another downlink control signaling to schedule the same UL data transmission to the UE.

For a DL data transmission, the UE can first receive a downlink control signaling indicating a plurality of parameters transmitted by the gNB. The plurality of parameters can be related to scheduling DL data transmission. Next, the UE can receive data transmitted by the gNB based on the plurality of parameters and report a HARQ-ACK information about whether the DL data is received successfully.

### Embodiment Examples 1: Redundancy Parity Block Transmission Scheduled by Control Signaling

In these embodiments, various redundancy parity block transmission scheduling methods are described. Indication information to schedule a redundancy parity block transmission can include at least one of the following: 1) an identifier for redundancy parity block transmission; 2) a number of code blocks related to the redundancy parity block transmission; 3) a number of code block groups of a transport block; 4) a generation sequence; 5) a rate matching bit pattern; 6) a hybrid automatic repeat request (HARD) processor number; 7) a redundancy version; 8) a frequency domain resource assignment; 9) a time domain resource assignment; 10) a spatial domain resource assignment; 11) a modulation; or (12) a coding scheme.

In some embodiments, the modulation and coding scheme can be used to determine the rate, modulation order, and the spectrum efficiency.

In some embodiments, the rate matching bit pattern can be used to determine a number of puncturing bits and puncturing bit locations for each code block.

The indication information can be indicated by a control signaling.

In some embodiments, the control signaling can be a PDCCH-based signaling.

In some embodiments, the control signaling can be a radio resource control (RRC) signaling.

In some embodiments, the PDCCH-based signaling can be a DCI. The indication information can be the information decoded by a UE from the received DCI.

The DCI can include a plurality of fields, and each field can indicate corresponding indication information. For example, the ‘identifier for redundancy parity block transmission’ field in the DCI represents a field used to indicate the information of whether the redundancy parity block is scheduled or not.

In some embodiments, the DCI format for scheduling a redundancy parity block transmission can be at least one of the following DCI formats:
1) DCI format 0-1;
2) DCI format 0-2;
3) DCI format 1-1; or
4) DCI format 1-2.

### Embodiment Examples 1-1: L1 Signaling Indication Design

### Method 1-1-1:

Information related to the redundancy parity block transmission can be indicated by a plurality of fields in the DCI that may be interpreted differently by a legacy user device as compared to a device that implements the disclosed techniques.

Two types of fields among the existing (legacy) DCI can be used to schedule a redundancy parity block transmission.

In some embodiments, bit information of a first type of fields can be interpreted as resource information related to the redundancy parity block transmission. Bit information of a second type of fields can be used to identify whether the DCI indicates the redundancy parity block transmission or not.

If the UE receives a DCI and the second type of fields set a predefined state, the first type of fields may be interpreted as the information related to the scheduled redundancy parity block transmission. In some embodiments, the predefined state can be where all bits of the field are set to ‘0’ or ‘1’.

If the DCI format is DCI format 0-1 or DCI format 0-2 with CRC scrambled by at least one of the following: 1) a C-RNTI, 2) a configured scheduling RNTI (CS-RNTI), 3) a semi-persistent CSI RNTI (SP-CSI-RNTI), 4) a modulation coding scheme cell RNTI (MCS-C-RNTI), or 5) a specific RNTI, then the first type of fields can include at least one of the following:
1) an uplink/supplementary uplink (UL/SUL) indicator;
2) a bandwidth part indicator;
3) a frequency domain resource assignment;
4) a time domain resource assignment;
5) a modulation and coding scheme;
6) a new data indicator;
7) a redundancy version;
8) a HARQ process number;
9) a transmit power control (TPC) command for a scheduled PUSCH;
10) a precoding information and number of layers;
11) antenna ports; or
12) a demodulation reference signal (DMRS) sequence initialization.

The first type of fields can also be the first downlink assignment index and the second downlink assignment index of DCI format 0-1.

The second type of fields can include at least one of the following:
1) an uplink shared channel (UL-SCH) indicator;
2) a CSI request;
3) a frequency domain resource assignment;
4) a modulation and coding scheme;
5) a new data indicator; or
6) a redundancy version.

The predefined state of the second type of fields can include at least one of the following:
1) an uplink shared channel (UL-SCH) indicator of “0”;
2) a CSI request of all zero(s);
3) either a frequency domain resource assignment of all zeros with a resource allocation type or a frequency domain resource assignment of all ones with a resource allocation type;
4) a modulation and coding scheme of all zero(s);
5) a new data indicator of “0”; or
6) a redundancy version of all zeros.

For example, the UE can receive the DCI format 0-1 with a CRC scrambled by a C-RNTI, MCS-C-RNTI, or CS-RNTI. If the predefined state of the second type of fields includes the UL-SCH indicator of “0” and the CSI request of all zero(s), the other fields can all be used to indicate the information related to the redundancy parity block transmission.

For example, the UE can receive the DCI format 0-1 with a CRC scrambled by a SP-CSI-RNTI. If the predefined state of the second type of fields includes: 1) the UL-SCH indicator of “0”, 2) the CSI request of all zero(s), and 3) the frequency domain resource assignment of all zero(s) with a resource allocation type 0 or resource allocation type 2, or the frequency domain resource assignment of all one(s) with a resource allocation type 1 or resource allocation type 2, the other fields can all be used to indicate the information related to the redundancy parity block transmission.

If the DCI format is DCI format 1-1 or DCI format 1-2 with CRC scrambled by at least one of the following: 1) a C-RNTI, 2) a CS-RNTI, or 3) a MCS-C-RNTI, then the first type of fields can include at least one of the following:
1) a bandwidth part indicator;
2) a frequency domain resource assignment;
3) a time domain resource assignment;
4) a rate matching indicator;
5) a modulation and coding scheme;
6) a new data indicator,
7) a redundancy version;
8) a HARQ process number;
9) a downlink assignment index;
10) a TPC command for scheduled PUSCH;
11) a PDSCH group index;
12) a new feedback indicator;
13) a number of requested PDSCH group(s);
14) antenna ports;
15) a code block group (CBG) transmission information (CBGTI);
16) a CBG flushing out information (CBGFI); or
17) a DMRS sequence initialization.

The first type of fields can also be a modulation and coding scheme, new data indicator, and redundancy version for a transport block 2 of DCI format 1-1.

The second type of fields can include at least one of the following:
1) a UL-SCH indicator;
2) a CSI request;
3) a frequency domain resource assignment;
4) a modulation and coding scheme;
5) a new data indicator;
6) a redundancy version; or
7) a HARQ process number.

The states of the second type of fields can include at least one of the following:
1) a UL-SCH indicator of “0”;
2) a CSI request of all zero(s);
3) either a frequency domain resource assignment of all zeros with a resource allocation type or a frequency domain resource assignment of all ones with a resource allocation type;
4) a modulation and coding scheme of all zeros;
5) a new data indicator of “0”;
6) a redundancy version of all zeros; or
7) a HARQ process number of all zeros.

Using the indication of L1 signaling can reduce the overhead of the higher layer signaling to enable the redundancy parity block transmission.

For example, the UE can receive the DCI format 1-1 with a CRC scrambled by a C-RNTI. If the states of the second type of fields includes: 1) the UL-SCH indicator of “0”, 2) the CSI request of all zero(s), and 3) the frequency domain resource assignment of all zero(s) with a resource allocation type 0, or the frequency domain resource assignment of all one(s) with a resource allocation type 1, the other fields can all be used to indicate the information related to the redundancy parity block transmission.

For example, the UE can receive the DCI format 1-1 with a CRC scrambled by a CS-RNTI. If the states of the second type of fields includes: 1) the UL-SCH indicator of “0”, 2) the CSI request of all zero(s), or 3) the frequency domain resource assignment of all zero(s) with a resource allocation type 0, or the frequency domain resource assignment of all one(s) with a resource allocation type 1, the other fields can all be used to indicate the information related to the redundancy parity block transmission.

### Method 1-1-2:

Information related to the redundancy parity block transmission can be indicated by a two-level DCI signaling scheme in which some fields of a legacy DCI will be interpreted differently by embodiments implementing the disclosed techniques compared to legacy devices.

In some implementation, the UE receives a DCI with the CRC scrambled by at least one of the following RNTIs: 1) a C-RNTI, 2) a MCS-C-RNTI, 3) a CS-RNTI, 4) a SP-CSI-RNIT, or 5) a specific RNTI, and only a second type of fields are available. Different states of the second type of fields can indicate different redundancy parity bits scheduling types. This DCI can be denoted as a first level DCI.

The UE can assume that the next received DCI schedules a redundancy parity block transmission after the UE detects a DCI indicating the second type of fields with the states which represents a validation of a DCI format being able to schedule the redundancy parity block transmission. The scheduling DCI that is able to schedule the redundancy parity block transmission can be denoted as a second level DCI.

If the UE detects a DCI at the slot n indicating the second type of fields with the states which represent the release of the DCI format being able to schedule the redundancy parity block transmission, the UE can assume that the received DCI after the slot n indicating normal data transmission without a redundancy parity block.

The scrambled RNTIs for the first and second level DCIs can be different.

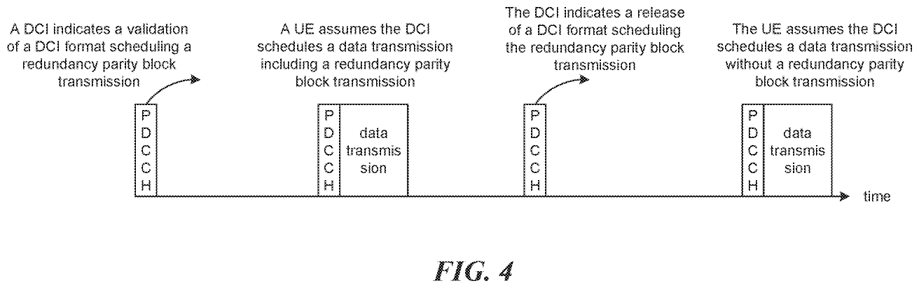

For example, FIG. 4 shows the procedure of a DCI indicating from the validation of a redundancy parity bits scheduling to the release of a redundancy parity bits scheduling.

### Method 1-1-3:

The information related to the redundancy parity block transmission can be indicated by one or more fields in the DCI.

In some embodiments, these fields can be the specific fields, which can be only reserved to indicate the information related to redundancy parity block transmission.

In some embodiments, the DCI format may be different from the current 15 types of DCI formats defined in NR, and the RNTI can be a specific RNTI that is dedicated for use as described herein. In some embodiments, the specific RNTI may be different from any of the well-known RNTIs such as RNTIs currently specified in the NR documentation, at least including a C-RNTI, MCS-C-RNTI, CS-RNIT, or SP-CSI-RNTI. In some embodiments, the specific RNTI can be only related to the DCI scheduling the redundancy parity bits transmission.

In some embodiments, the DCI format can be a new DCI format only used for the UE supporting the release version after NR Release 16.

In some embodiments, the DCI format can be at least one of the DCI format 0-1, DCI format 0-2, DCI format 1-1, or DCI format 1-2, and the RNTI scrambling the CRC of the DCI can be a specific RNTI. The specific RNTI can be different from the C-RNTI, MCS-C-RNTI, CS-RNIT, SP-CSI-RNTI, and can be related to the redundancy parity block scheduling.

In some embodiments, the UE may not expect to receive/send a redundancy parity block transmission if the transport block is divided into one code block.

In some embodiments, the UE may not expect to calculate the TBS if the scheduled data transmission including a redundancy parity block transmission is a re-transmission for the transport block.

In some embodiments, the UE may be required to calculate the TBS if the scheduled data transmission including a redundancy parity block transmission is an initial transmission or a first transmission for the transport block.

For a redundancy parity block transmission and the initial transmission of a transport block, the UE can assume that the resource allocation is used for both the transport block and the redundancy parity block transmission, and the UE may determine the TBS based on the indication of the resource allocation related to TBS determination in the DCI. Such implicit understanding by the UE can avoid the waste of the resource for transmitting the additional bits of the redundancy parity block.

For a redundancy parity block transmission and the initial transmission of a transport block, the UE can assume that the resource allocation, which is used for the transport block and the redundancy parity block transmission, is indicated by different fields in the same DCI or indicated by the same fields in a different DCI; the UE may determine the TBS based on the indication of the resource allocation related to the transport block in the DCI. Such implicit understanding by the UE can provide a clear resource allocation for the transport block and the redundancy parity block, and provide a better coding gain when there is no rate matching bit pattern for system code block and the redundancy parity block.

In some embodiments, for a first transmission, the fields related to redundancy parity block may not be present. In some embodiments, for a re-transmission, the fields related to redundancy parity block may be present.

### Other Details

Redundancy parity block transmission can be transmitted on the PUSCH and PDSCH.

In some embodiments, the redundancy parity block can be scheduled to transmit in an active UL or DL bandwidth part (BWP) on a secondary serving cell (SCell).

In some embodiments, the redundancy parity block can be scheduled to transmit in an active UL or DL BWP on a primary serving cell (PCell).

In some embodiments, the redundancy parity block can be scheduled to transmit in an active UL or DL BWP on a cell or cell group(s) if the cell group is configured.

In some embodiments, the redundancy parity block can be scheduled for a case of a carrier aggregation/dual connectivity (CA/DC) configuration.

In some embodiments, the redundancy parity bits scheduling cannot be used for a case of cross-slot scheduling configuration.

The fields of a DCI used to indicate the resource allocation of a redundancy parity block transmission can include at least one of the following: 1) a frequency domain resource assignment, 2) a time domain resource assignment, 3) a modulation and coding scheme, 4) a new data indicator, 5) a redundancy version, 6) a HARQ process number, 7) a CBG transmission information (CBGTI), or 8) antenna port(s).

In some embodiments, the bit-width of the resource allocation fields in a DCI related to redundancy parity block for a transmission cannot be larger than that of the system code blocks of the transport block.

For the Methods 1-1-1, 1-1-2, and 1-1-3, the indication information related to the redundancy parity block transmission of the first or the second type of fields in a DCI can be available for the UE when the UE supports the redundancy parity block transmission.

In some embodiments, if the redundancy parity block is scheduled by a DCI together with the transport block, the coded redundancy parity block can be concatenated immediately after the coded bits of the transport block.

### Other Details for the Uplink Data Transmission

If the HARQ-ACK bits is transmitted on a PUSCH or PUCCH, additional bits to indicate the number of error system code blocks of the last recent transmission of the same TB may be transmitted immediately behind the existing HARQ-ACK bit. Otherwise, the redundancy parity block transmission may be transmitted based on the reported HARQ-ACK bits which is the bitmap of each code block group for a same TB.

If the specific higher layer parameters or the L1 signaling configures that the UE should receive or transmit the redundancy parity block, corresponding reported quantities associated with the redundancy parity block can multiplex with the HARQ-ACK bit of the same TB. The reported quantities can include the number of error system code blocks, CSI, L1 signal-to-noise and interference ratio (L1-SINR), or L1 reference signal received power (L1-RSRP).

### Embodiment Examples 1-2: Generation Sequence Indication

A generation sequence can be determined by a number of code blocks and a number of code block groups for a transport block.

In some embodiments, the generation sequence can be indicated as an index of a generation sequence list. The generation sequence list can be configured by a higher layer parameter.

In some embodiments, the generation sequence can be obtained by the indices of the code blocks associated with the redundancy parity block.

In some embodiments, the generation sequence can be configured by a high-layer parameter. For example, the high-layer parameter may be a communicated by a radio resource control (RRC) signaling.

In some embodiments, the high-layer parameter can configure a plurality of generation sequence lists. The higher layer parameter can select a plurality of indices of a generation sequence from the plurality of generation sequences. Herein, the high-layer parameter is radio resource control signaling and the higher layer parameter is the medium access control (MAC) signaling.

In some embodiments, the high-layer parameter can configure a plurality of generation sequence lists. The higher layer parameter can select a plurality of indices of generation sequence from the plurality of generation sequences. The DCI can indicate one generation sequence among the plurality of generation sequences.

For example, the transport block can be divided into N code blocks. The total number of the generation sequence for the redundancy parity block transmission can be M=A_{N}^{N}−C_{N}⁰−C_{N}¹, as shown in Table 5.

TABLE 5

| | The number of | The list of the | |
|---|---|---|---|
| | system code | generation sequence for all | |
| | blocks groups | redundancy parity block Pr | |
| List | associated with | sequence | Generation sequence |
| index | a single Pr | index | of the list |
| 1 | 1 | 1 | {1 1 1 1 . . . 1} |
| 2 | 2 | 1 | {0 0 . . . 0 1 1} |
| | | . . . | . . . |
| | | 2^{N} − C_{N}⁰ − C_{N}^{N} | {1 1 . . . 1 1 0} |
| . . . | . . . | . . . | . . . |
| N − 1 | N − 1 | 1 | {0 0 0 . . . 1 1} |
| | | . . . | |
| | | C_{N}² | {1 1 0 . . . 0 0} |

In some embodiments, the generation sequence for redundancy parity block transmission can be associated with a code block group configuration.

For a CBG-based transmission, a number of transmitted redundancy parity block can be determined by a higher layer parameter maxCodeBlockGroupsPerTransportBlock for a PUSCH or higher layer parameters maxCodeBlockGroupsPerTransportBlock and maxNrofCodeWordsScheduledByDCI for a PDSCH.

For example, the total number of code blocks divided by the transport block size can be C=10 and the maximum number of CBGs per transport block configured by the high layer parameter maxCodeBlockGroupsPerTransportBlock in PUSCH-ServingCellConfig can be N=4. Thus, the number of CBGs can be M=min(4,10). The indices of code blocks of each group can be {[0 1 2], [3 4 5], [6 7], [8 9]}. Therefore, the maximum number of redundancy parity blocks for this transport block can be equal to M+1, and the generation sequences of the redundancy code blocks can be shown as in Table 6.

TABLE 6

| Index | Generation sequence |
|---|---|
| 1 | {1 1 1 0 0 0 0 0 0 0} |
| 2 | {0 0 0 1 1 1 0 0 0 0} |
| 3 | {0 0 0 0 0 0 1 1 0 0} |
| 4 | {0 0 0 0 0 0 0 0 1 1} |
| 5 | {1 1 1 1 1 1 1 1 1 1} |

In one embodiment, for the first transmission, the gNB can send a DCI indicating the data transmission including a redundancy parity block transmission with an index of the generation sequence as 5.

In another embodiment, after the first transmission, if the gNB receives that the bitmap of the HARQ-ACK information for the CBG-based PDSCH transmission indicates at least one of the code blocks of the first CBG and the third CBG are not received successfully, the gNB may send a DCI indicating the redundancy parity block transmission with indices of the generation sequence as 1 and 3, respectively.

In yet another embodiment, after the first transmission, if the gNB receives that the bitmap of the HARQ-ACK information for the CBG-based PDSCH transmission indicates at least one of the code blocks of each CBG are not received successfully, the gNB may send a DCI indicating the redundancy parity block transmission with an index of the generation sequence as 5.

In some embodiments, if there are more than one redundancy parity block transmission, the generation sequence for the redundancy parity blocks can be indicated as a bitmap. Each generation sequence indication for a redundancy parity block can have the same bit-width.

### Embodiment Examples 2: Rate Matching Bit Pattern for Redundancy Parity Block Transmission

In these embodiments, a method of determining a rate matching bit pattern for a redundancy parity block transmission is described.

In some embodiments, the Rate Matching Bit Pattern is determined by the following predefined functions or procedures.

In some embodiments, the Rate Matching Bit Pattern is configured by the higher layer parameters, e.g. through RRC signaling or MAC signaling.

In some embodiments, the rate matching bit pattern can be used to indicate a number of puncturing bits and a corresponding puncturing bit location of the code blocks for the data transmission including redundancy parity block.

The indication of the rate matching bit pattern can be used to determine a number of puncturing bits and the puncturing bit location of the code blocks for the data transmission including a plurality of scheduled redundancy parity bits.

In some embodiments, the rate matching bit pattern for the redundancy parity block transmission can be determined by at least one of the following factors for the transport block:
1) a total number of transmitted bits of each system code block;
2) a number of code blocks of the transport block;
3) a system code block size; or
4) a value of lifting size (Zc);

In some embodiments, the rate matching bit pattern for the redundancy parity block transmission can be determined by at least one of the following parameters for the transport block:
1) a transport block size;
2) a number of code blocks related to one redundancy parity block; or
3) a value of lifting size (Zc);

These parameters can be indicated or determined by the DCI scheduling a redundancy parity bits transmission.

In this embodiment, the puncturing bit locations for a plurality of code blocks cannot be overlapped, and the puncturing bit locations for another plurality of code blocks can be overlapped. The code blocks can represent a total number of code blocks for the scheduled redundancy parity block transmission.

For a first transmission, the number of puncturing bits for each code block can be determined by the number of transmitted bits of a number of code blocks. The number of code blocks can be equal to the number of scheduled redundancy parity blocks.

For the first transmission, the UE cannot require puncturing the additional bits of each code block if some conditions are met as at least one of the following events:
1) a code rate is in a value range;
2) a TBS is in a value range;
3) a modulation order is in a value range; or
4) a scheduled data transmission is a re-transmission for the transport block.

In some embodiments, the value range of the code rate can be included in the range of ¼˜⅚. In some embodiments, the value range of the TBS can be included in the range of 3840˜10⁶. In some embodiments, the value range of the modulation order can be included in the range of 2-6.

### Embodiment 2-1: Puncturing Bit-Locations are not Overlapped Among Code Blocks of Different Groups

When a redundancy parity block is transmitted together with its corresponding system code blocks, additional puncturing may be needed for all code blocks including the redundancy parity block to accommodate a channel capacity. This additional puncturing can usually be operated after a traditional rate matching as mentioned in the previous section. The computation of the number of punctured bits for each code block is described herein.

In some embodiments, the elements of the vector Punct set can represent the number of punctured bits for a plurality of the system code blocks for a TB.

```
If L/(N + 1) > Zc
  Punct0 = Zc;
  Punct1 = L − Zc × N;
  Punct_set = [ Punct0 × ones(1, N), Punct1 ];
else
  Punct0 = floor( L/(N + 1) );
  Punct1 = Punct0 + 1;
  N1 = mod(L, (N + 1));
  N0 = N + 1 − N1;
  Punct_set = [ Punct0 × ones(1, N0), (Punct1) × ones(1, N1) ];
end
```

where L is the bit length of each code block after a NR-LDPC rate matching, N is the number of code blocks that are used to generate the redundancy parity block, and Zc is the lifting size.

All of the code blocks including the redundancy parity block can be divided into several groups. For code blocks in each group, the punctured bit-locations can be the same. For code blocks in different groups, the punctured bit-locations can be different. In some embodiments, the code blocks including redundancy parity block can be divided into M groups, where M is an integer not less than 1. In some embodiments, the additional punctured bits of each code block in one group can be located at a tail of the code block after a LDPC rate matching. In some embodiments, the additional punctured bits of each code block in one group can be located at the start of each code block after the NR-LDPC rate matching.

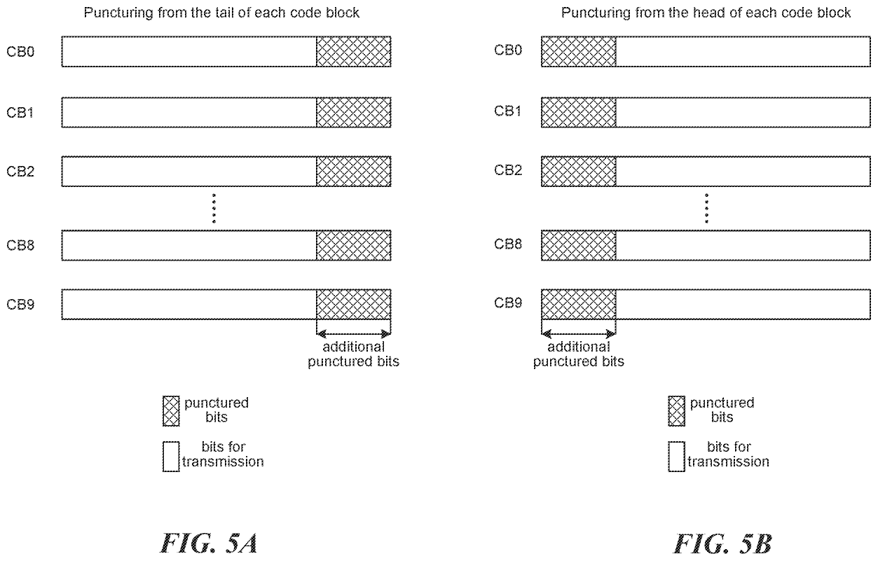

For example, there can be ten code blocks (e.g., CB0, CB1, . . . , CB9) including a redundancy parity block for a TB. The ten code blocks can be divided into one group. The bit sequence of each code block can be the code block after the LDPC rate matching. Namely, the location of punctured bits among all of code blocks can be the same. For example, the punctured bits can be located at the tail or at the head of each code block, as shown in FIGS. 5A and 5B, respectively.

In some embodiments, the punctured bit locations among the code blocks in one group can be the same.

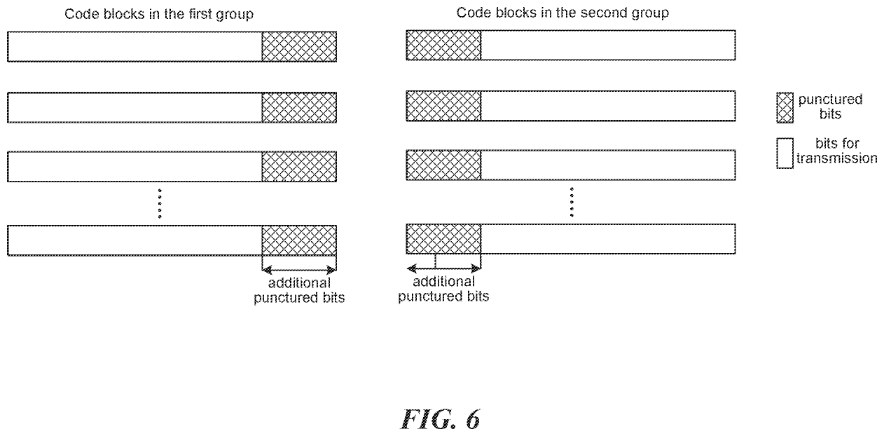

For example, there can be ten code blocks (e.g., CB0, CB1, . . . , CB9) including a redundancy parity block for a TB. As shown in FIG. 6, The ten code blocks can be divided into two groups, and each group includes 5 code blocks. In a first group, indices of code block can be {0, 2, . . . , 8}. In a second group, indices of code block can be {1, 3, . . . , 9}. The punctured bits of each code block in the first group can be punctured from a tail of each code block after rate matching, and the punctured bits of each code block in the second group can be punctured from a head of each code block after a rate matching.

In some embodiments, the punctured bit locations among code blocks in different groups can be non-overlapped.

For example, there can be ten code blocks (e.g., CB0, CB1, . . . , CB9) including a redundancy parity block for a TB. The ten code blocks can be divided into ten groups. The punctured bit locations among all of code blocks can be non-overlapped.

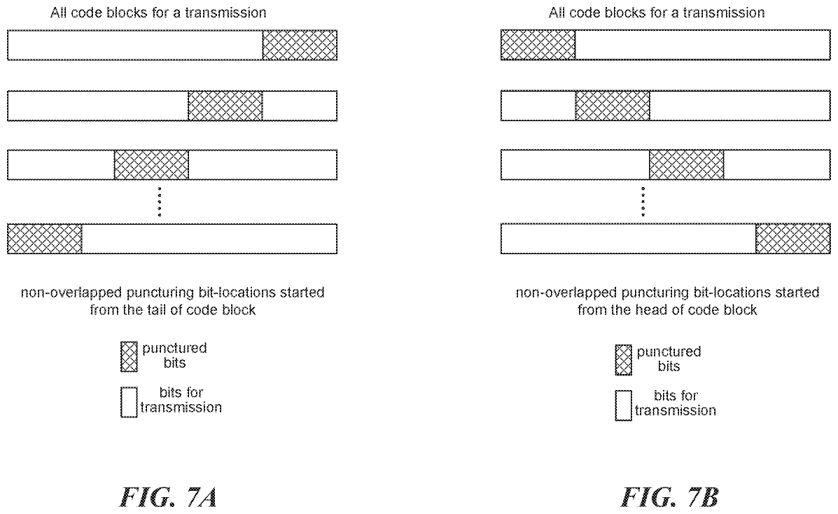

The punctured bit locations of a first code block can be punctured from a tail or head of the first code block after a rate matching, as shown in FIGS. 7A and 7B, respectively.

For the other code blocks, the punctured bit locations can be immediately adjacent to the punctured bit location of a former code block.

In some embodiments, the punctured bit locations among code blocks in different groups can be non-overlapped.

In some embodiments, the additional punctured bit locations of system code blocks cannot overlap with that of the punctured 2*Zc bits located at a head of each code block after the LDPC rate matching for a transmission with the redundancy parity block.

In some embodiments, the additional punctured bit locations of redundancy parity block cannot overlap with that of the punctured 2*Zc bits located at a head of each code block after the LDPC rate matching for a transmission with the redundancy parity block.

In some embodiments, the additional punctured bit locations of system code blocks and redundancy parity block cannot overlap with that of the punctured 2*Zc bits located at a head of each code block after the LDPC rate matching for a transmission with the redundancy parity block.

### Embodiment 2-2: Fixed Total Punctured Number of Bits at Specific Bit Locations for Code Blocks Other than the Redundancy Parity Block

In this embodiment, a total number of punctured bits (Ls) and punctured bit locations for all system code blocks of a TB can be predetermined. Upon determining the total number of punctured bits for all system code blocks, a number of punctured bits for a redundancy parity block can be obtained by (L−Ls), where L represents a length of a code block after a LDPC rate matching.

The Ls and punctured bit locations of all of system code blocks can be predetermined by a predefined set of column indices (Sₚ) of the selected base graph, the lifting size (Zc), the lifting size set index (i_{LS}), and/or the number of system code blocks (Cₛ) associated with the redundancy parity block.

The predefined set of column indices (Sₚ) of the selected base graph, which is used to determine the punctured bit locations, can be determined by the rate R allocated by a DCI, the system code block size (CBS), the number of system code blocks (Cₛ), and/or a threshold thr1 representing the number of elements of a column in Sₚ.

Elements in Sₚ can be indices of columns with the number of elements larger than the threshold thr1 in the selected base graph.

The total number of punctured bits (Ls) can be equal to the multiple of the lifting size (Zc), the minimum value between the number of system code blocks (Cₛ), and the total number of elements (Nₑ) in Sₚ.

The column indices 1 and 2 cannot be included in the Sₚ.

In some embodiments, the column indices in Sₚ can be stored in the order of the column indices of from large to small.

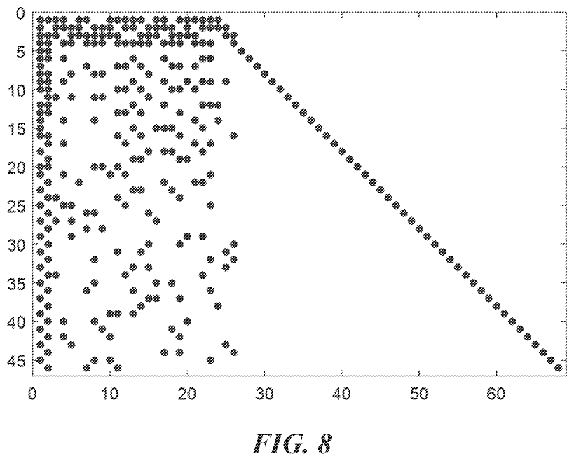

For example, for a base graph 1 as shown in FIG. 8, the Sₚ can include at least one of the elements in the set {4, 5, 8, 11, 12, 13, 14, 15, 17, 18, 19, 22, 23}. Fora base graph 2, the Sₚ can include at least one of the elements in the set {3, 6, 8, 11, 12, 13, 14}.

In some embodiments, the punctured columns can be columns with indices of the first min(Cₛ, Nₑ) elements in the Sₚ.

In some embodiments, the punctured columns can be columns with indices of the last min(Cₛ, Nₑ) elements in the Sₚ.

In another embodiments, the column indices in Sₚ can be stored in an order of the number of elements of each column from large to small.

For example, for the base graph 1, the Sₚ can include at least one of the elements in the set {19, 23, 13, 11, 8, 22, 14, 4, 18, 17, 15, 12, 5}. For the base graph 2, the Sₚ can include at least one of the elements in the set {12, 6, 8, 14, 3, 13, 11}.

Cr can be a number of redundancy parity blocks. The Cr cannot be larger than the value of floor(Cs/2).

For example, R=⅔, Cs=10, Cr=1, Qₘ=2, L=12300 and Zc=384 for the base graph 1. The elements of the base graph 1 are shown in FIG. 8. A black dot represents an element of base graph 1 corresponding to a specific integer.

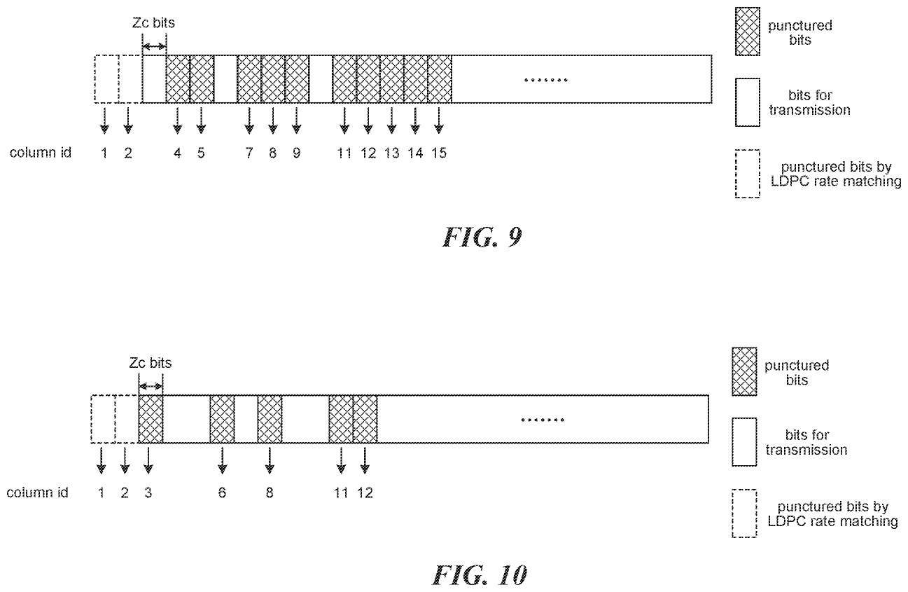

Except for the first two columns, if thr1 is equal to 8, the predefined set of punctured column indices (Sₚ) of the base graph 1 can be {4, 5, 8, 11, 12, 13, 14, 15, 17, 18, 19, 22, 23}. The total number of elements in Sₚ can be Nₑ=13 except for the index 1 and 2. Each column index in the predefined set can represent the corresponding Zc punctured bit locations. The total number of punctured bits can be Zc*min(Cs, =384*10=3840. The puncture column indices can be the first ten elements in Sₚ as {4, 5, 7, 8, 9, 11, 12, 13, 14, 15}. The punctured pattern for all system code blocks is shown in FIG. 9.

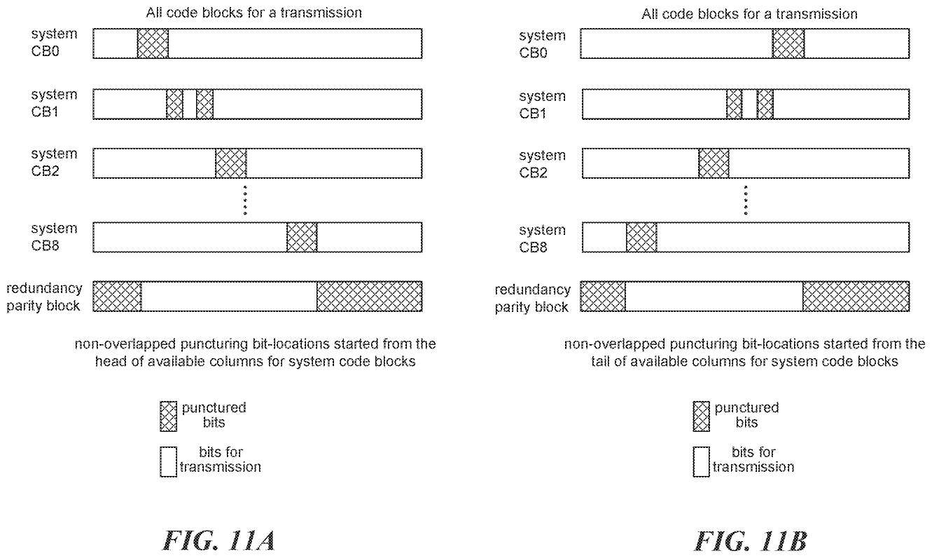

For base graph 2, R=¼, Cs=5, Cr=1, Qₘ=2, L=14784 and Zc=384 for the base graph 2. Except for the first two columns, if thr1 is equal to 8, the predefined set of punctured column indices (Sₚ) of the base graph 2 can be {3, 6, 8, 11, 12, 13, 14}. The total number of elements in Sₚ can be Nₑ=7 except for the index 1 and 2. Each column index in the predefined set can represent the corresponding Zc punctured bit locations. The total number of punctured bits can be Zc*min(Cr, =384*5=1920. The puncture column indices can be the first ten elements in Sₚ as {3, 6, 8, 11, 12}. The punctured bit locations for all system code blocks are shown in FIG. 10.

When the redundancy parity block is transmitted together with its corresponding system code blocks, the total additional number of the punctured bits for all of the code blocks including the redundancy parity block can be equal to the length of the redundancy parity block after a LDPC rate matching operation.

thr1 can be an integer not less than 8. The number of punctured bits of each code block other than the redundancy parity block may not be larger than Zc. The number of punctured bits of each code block other than the redundancy parity block may not be larger than that of the redundancy parity block. The total number of punctured bits of all system code blocks may not be larger than Cs*Zc.

In some embodiments, the punctured pattern for each system code block can reuse the punctured method as disclosed in Embodiment 1.

In some embodiments, for a TB, the punctured bit-locations among all of its code blocks can be different and/or non-overlapped.

The first method of computation of the number of punctured bits for each code block is shown as follows.

```
If Lw/N > Zc
  Punct0 = Zc;
  Punct1 = L − Zc × N;
else
  Punct0 = floor( Lw/N );
  Punct1 = L − Punct0 × N;
end
Punct_set = [ Punct0 × ones(1, N), Punct1 ];
```

where Lw is the total bit length of α_{w}*Zc and α_{w} is the number of columns with the number of elements>thr1 of the H_{BG}, and where L is the bit length of each code block after LDPC rate matching, N is the number of code blocks that are used to generate the redundancy parity block and Zc is the lifting size.

The second method of computation of the number of punctured bits for each code block is shown as follows:

```
If Lw/N > Zc
  Punct0 = Zc;
  Punct1 = L − Zc × N;
  Punct_set = [ Punct0 × ones(1, N), Punct1];
else
  Punct0 = floor( Lw/N );
  Punct1 = Punct0 + 1;
  N1 = mod(Lw, N);
  N0 = N − N1;
  Punct2 = L − Lw;
  Punct_set = [ Punct0 × ones(1, N0), (Punct1) × ones(1,N1), Punct2] ;
end
```

where Lw is the total bit length of α_{w}*Zc and a_{w} is the number of columns with the column weight>w of the H_{BG}, and where L is the bit length of each code block after NR-LDPC rate matching, N is the number of code blocks that are used to generate the redundancy parity block and Zc is the lifting size.

For example, there can be ten code blocks including the redundancy parity block for a TB (namely, Cₛ=9, Cᵣ=1), the code rate can be 2/3, the lifting size Zc can be 320 and the number of bits of each code block after the LDPC rate matching can be 9804. Assuming thr1=10, the column indices in Sₚ can be {4, 8, 11, 13, 14, 19, 22, 23}. Then, for system code blocks, the punctured bits can be {284, 284, 284, 284, 284, 285, 285, 285, 285} based on the second method of calculating the number of punctured bits. For redundancy parity block, the punctured bits can be 7244. The punctured bit location of each code block can be punctured from a head or tail of the code block, as shown in FIGS. 11A and 11B, respectively.

### Embodiment 2-3: No Additional Punctured Bits for all of System Code Blocks of a TB for Redundancy Parity Block Transmission

In this embodiment, there can be no additional punctured bits for system code blocks and an associated redundancy parity block. A number of transmitted bits of a redundancy parity block can be equal to or smaller than a number of bits of the system code block after a LDPC rate matching. Therefore, a target code rate R for a TB with an additional redundancy parity block transmission may be decreased.

For example, if the redundancy parity block with the same size as the system code block is transmitted, the rate for a TB can decrease as R*Cₛ/(Cₛ+Cᵣ), where Cₛ is the number of system code blocks and Cᵣ is the number of redundancy parity block.

The redundancy parity block transmission can be triggered by predefined conditions.

The number of transmitted bits of redundancy parity block can be determined by a set of parameters.

For a transmission, the predefined conditions can include at least one of the following: 1) a HARQ process number indicated by a DCI is not smaller than or equal to a threshold h1, 2) a redundancy version indicated by a DCI is larger than or equal to a threshold h2, 3) a scheduling DCI format such as the DCI format 0-1/1-1 and/or DCI format 0-2/1-2, 4) the code rate R of the TB indicated by a DCI is not smaller than h3, 5) a modulation order Qₘ of the TB indicated by a DCI is not smaller than h4, 5) the number of system code blocks for the TB is not smaller than h5 or the TBS is not larger than h8, 6) related feedback parameters include a number of error code blocks received by a UE for the last recent transmission not larger than a threshold h6, or 7) reported quantities related to a channel state or beam measurement is not smaller than a threshold h7, such as a CSI-RS resource indicator (CRI), channel quality indicator (CQI), RSRP and SINR and so on.

The related feedback parameters can be configured by high-layer parameters and reported by the UE.

For example, there can be 9 code blocks, which is larger than h5=5, including the redundancy parity block for a TB (e.g., Cₛ=9). The code rate can be 2/3 which is larger than the h3=1/3, the lifting size Zc can be 320, and the number of bits of each code block after the LDPC rate matching can be 9804.

If there is a first or initial transmission, the redundancy parity block cannot be transmitted for the next transmission of the TB. The transmitted bits of redundancy parity block can be zero.

For re-transmissions, if the number of error code blocks received by the UE of the TB is not larger than h6=9, the redundancy parity block can be transmitted for the next transmission of the TB. The number of transmitted bits of the redundancy parity block can be 9804.

In another example, there can be 9 code blocks, which is larger than h5=5, including the redundancy parity block for a TB (e.g., Cₛ=9). The code rate can be 2/3 which is larger than the h3=1/3, the lifting size Zc can be 320, and the number of bits of each code block after LDPC rate matching can be 9804.

If there is a first or initial transmission, the redundancy parity block can be transmitted for the next transmission of the TB. The transmitted bits of redundancy parity block can be 9804.

For a first re-transmission, if the number of error code blocks received by the UE of the TB is not larger than h6=10, the redundancy parity block can be transmitted for the next transmission of the TB. The number of transmitted bits of the redundancy parity block can be 9804.

For other re-transmissions, if the number of error code blocks received by the UE of the TB is not larger than h6=9, the redundancy parity block can be transmitted for the next transmission of the TB. The number of transmitted bits of the redundancy parity block can be 9804.

A set of parameters can include or be determined by at least one of the following: 1) a number of information bits of each system code block (CBS), 2) a number of bits of each system code block, 3) a number of system code blocks, 4) a redundancy version and its corresponding start position for a LDPC coding in Rel-16, 5) a redundancy version and a new corresponding start position for redundancy parity block only, or 6) a predetermined set of scaling factor.

The predetermined set of a scaling factor used to modify the number of transmitted bits of redundancy parity block can be determined by the number of system code blocks, a rate of TB without redundancy parity block, a modulation order, and/or a set of thresholds of the predefined conditions.

A maximum value of elements in the predetermined set of the scaling factor cannot be larger than 1.

A minimum value of elements in the predetermined set of the scaling factor cannot be smaller than 0.

A number of elements in the predetermined set of the scaling factor cannot be larger than 6. The elements in the predetermined set of the scaling factor cannot be smaller than 0 and larger than 1. For example, the predetermined set of the scaling factor can include at least one of the following values: {0, ¼, ⅓, ⅔, ⅘, 1}. For example, the predetermined set of the scaling factor can include at least one of the following values: {0, ¼, ½, ¾, 1}.

In some embodiments, the available values of the predetermined set of the scaling factor can be at least one of the followings: [0.125, 0.25, 0.375, 0.5, 0.625, 0.75, 0.875, 1].

In some embodiments, a product of the length of each encoded code block and the scaling factor can be an integer.

In some embodiments, the scaling factor can be determined by the information indicated by the L1 signaling or the higher layer signaling. In some embodiments, the scaling factor can be reported by the UE.

For example, there can be 9 code blocks, which is larger than h5=5, including the redundancy parity block for a TB (e.g., Cₛ=9). The code rate can be 2/3 which is larger than the h3=1/3, the modulation order Qₘ can be 2, the lifting size Zc can be 320, and the number of bits of each code block after LDPC rate matching can be 9804. The set of the scaling factor can be {½, 1, 1, 1}.

If there is the first or initial transmission, the redundancy parity block can be transmitted for the next transmission of the TB. The transmitted bits of redundancy parity block can be func(func(9804*½)/Qₘ)*Qₘ, where the func( ) represents rounding down, rounding up, or rounding.

For re-transmissions, if the number of error code blocks received by the UE of the TB is not larger than h6=9, the redundancy parity block can be transmitted for the next transmission of the TB. The number of transmitted bits of the redundancy parity block can be 9804.

In some embodiments, the redundancy parity bock transmission can be determined by the combination of the predefined conditions and the set of parameters.

In some embodiments, h3 cannot be larger than ⅔. In some embodiments, h4 cannot be larger than 4. In some embodiments, h5 cannot be larger than 10. In some embodiments, h8 cannot be larger than 38240 bits for the BG2 and 84240 bits for the BG1. In some embodiments, h6 cannot be smaller than the number of system code blocks associated with the redundancy parity block minus 1.

In some embodiments, C2 cannot be smaller than 35. In some embodiments, h3 cannot be smaller than 0.95. In some embodiments, h4 cannot be smaller than 8. In some embodiments, h8 cannot be smaller than 1 million bits for the BG2 and 10 million bits for the BG1.

In the above description, the system code blocks can be the code blocks associated with the transmitted redundancy parity block. In some embodiments, the total code blocks of a TB can be divided into more than one code block group (CBG) based on CBG-based PDSCH transmission. In some embodiments, there can be only one redundancy parity block associated with the total code blocks in all of the groups. In some embodiments, there can be more than one redundancy parity blocks, and each redundancy parity block can be associated with the total code blocks in a corresponding code block group. The number of redundancy parity blocks can be equal to or smaller than the number of the code block group.

### Embodiment 2-4: The Redundancy Parity Block Used for Re-Transmission

In some embodiments, the redundancy parity block can be used for the first transmission and the additional puncturing methods are described in the above Embodiment 2-1 and Embodiment 2-2.

In some embodiments, the redundancy parity block can be used for a specific transmission of a TB in the cases of being satisfied with the redefined conditions, and the transmission methods are described in the above Embodiment 2-3.

As described herein in Embodiment 2-4, for re-transmission, the redundancy parity block can also be used to reduce the total required number of resources. For example, the number of resource elements used by all of the transmission for a UE to receive the TB successfully can be reduced by the redundancy parity block transmission by decreasing either the amount of the scheduling resource of each transmission or the total required number of transmissions.

The redundancy parity block can be transmitted base on a predefined event. The predefined event for a transmission can be at least one of the following:
1) a number of error system code blocks which are not received successfully by the UE is smaller than or equal to a threshold;
2) a number of a code block group which contains a code block that is not received successfully by the UE for the CBG-based transmission is smaller than or equal to a threshold;
3) a value of current times of a transmission for the same TB which is counted from a first or initial transmission is smaller than or equal to a threshold and larger than another threshold;
4) a reported SINR value before or after a most recent transmission of the TB is smaller than or equal to a threshold and larger than another threshold;
5) reported quantities defined in Rel-16 from a most recent CSI/synchronization signal block (CSI/SSB) measurement;
6) a bit error rate (BER) or block error rate (BLER) evaluated by the UE is larger than the target BLER or larger than the target BLER*0.01;
7) an average value of the absolute value of likelihood log ratio (LLR) of each error code block;
8) a reported quantity related to the likelihood log ratio (LLR) of the transmitted bits new to Rel-16;
9) a BER of a most recent transmitted redundancy parity block of the TB;
10) a most recent transmitted redundancy parity block of the TB is not received successfully;
11) a reduced number of error system code blocks after receiving a most recent transmitted redundancy parity block of the TB is larger than a threshold;
12) a rate R of the system code block of the TB is larger than a threshold;
13) a number of system code blocks of the TB is larger than a threshold; or
14) the number of error system code blocks of the last recent transmission is smaller than a threshold.

An error code block can represent a code block that does not pass a code block (CB) CRC check or does not received successfully.

An error code block can represent a code block that does not pass a transport block (TB) CRC check or does not received successfully.

The BER can represent the bit error rate of the TB. The BER can also represent a number of error information bits divided by the total number of transmitted bits. The BLER can represent the block error rate of the TB. The BLER can also represent the number of error code blocks divided by the total number of code blocks of the TB.

For example, when the UE or gNB meets an event where a number of the system code blocks reported by the UE, which are not received successfully by the UE, is smaller than or equal to a threshold, the UE or gNB can assume that the redundancy parity block can be transmitted. Various specific applications of this event definition may be as follows:
1) For a first re-transmission, namely a second transmission, the event is applied as a number of error code blocks of a first or initial transmission is not smaller than Ce1.
2) For a second re-transmission, namely a third transmission, the event is applied as a number of error code blocks of a second transmission is not smaller than Ce2.
3) For a third re-transmission, namely a fourth transmission, the event is applied as a number of error code blocks of a third transmission is not smaller than Ce3.

In some embodiments, Ce1 can be an integer that is not smaller than the value of floor(C*0.9). In some embodiments, Ce2 can be an integer that is not larger than the value of floor(C*0.9). In some embodiments, Ce3 can be an integer that is not larger than the value of floor(C*0.9).

For other next re-transmissions of a TB, the condition triggering the redundancy parity block transmission can be similar to a former transmission of the same TB.

In some embodiments, the number of error blocks of a TB for a current transmission can be reported by UE. In some embodiments, the number of error blocks of a TB for the current transmission reported by UE can be transmitted in the PUCCH. In some embodiments, the number of error blocks of a TB for the current transmission reported by UE can be transmitted in the PUSCH. In some embodiments, the number of error blocks of a TB for the current transmission can be multiplexed.

In some embodiments, the redundancy parity block can be used for the first re-transmission or the second transmission if the recent SINR reported or measured by the UE is not smaller than S1.

In some embodiments, the redundancy parity block can be used for the second re-transmission or the third transmission if the recent SINR reported or measured by the UE is not smaller than S2.

In some embodiments, the redundancy parity block can be used for the third re-transmission or the fourth transmission if the recent SINR reported or measured by the UE is not smaller than S3.

In some embodiments, S1 can be the addition of SNR at target BLER=10% for the MCS of the initial transmission and Δ1. In some embodiments, S2 can be the addition of SNR at target BLER=10% for the MCS of the initial transmission and Δ2. In some embodiments, S3 can be the addition of SNR at target BLER=10% for the MCS of the initial transmission and Δ3.

In some embodiments, the values of 41, 42 and 43 can be configured by higher layer parameter.

In some embodiments, the values of 41, 42 and 43 can be at least one of the following: [3, 6, 9, 12] dB.

In some embodiments, the values of 41, 42 and 43 can be different from each other.

### Embodiment 3: Higher Layer Parameter Related to Redundancy Parity Block Transmission

Higher layer parameters related to a redundancy parity block transmission can include the following two types: 1) related UE features or capabilities reported by a UE; and 2) a high-layer parameter related to resource configuration for the redundancy parity block transmission.

As described herein, UE features associated with the redundancy parity block transmission are disclosed.

The UE features can include at least one of the following:
1) a feature to determine a number of transmitted redundancy parity blocks for a TB;
2) a feature to determine HARQ-ACK information associated with a redundancy parity block;
3) a feature to determine that the UE is able to process the redundancy parity block transmission;
4) a feature to determine a size of the transmitted redundancy parity block; or
5) a feature to determine a frequency domain resource used to transmit the redundancy parity block.

The high-layer parameters related to resource configuration for redundancy parity block transmission can include at least one of the following:
1) enabling the redundancy parity block transmission for a TB;
2) a generation sequence candidate lists or determining procedure;
3) a specific resource configuration for the redundancy parity block transmission; or
4) a search space set and CORESET configuration used to monitor a PDCCH scheduling the redundancy parity block transmission.

In some embodiments, the high-layer parameters related to resource configuration for the redundancy parity block transmission can be included in the radio resource control (RRC) signaling.

In the above description, the TBS can represent a total number of information bits which is transmitted in the resource allocated by the DCI or higher layer parameter.

In some embodiments, the transport blocks (TBs) can be transmitted in a 14 consecutive-symbol duration for a normal cyclic prefix (CP) or in a 12 consecutive-symbol duration for an extended cyclic prefix ending at a last symbol of a most recent PDSCH transmission within an active BWP on a serving cell.

In some embodiments, the allocated resource can be consecutive in time domain and frequency domain.

In the above description, each encoded code block of a TB can include an information bits part and parity bits part. In some embodiments, each code block carrying the information bits of the TB can be a system code block. In some embodiments, an encoder can be named as a system encoder.

Some embodiments may preferably incorporate the following solutions as described herein.

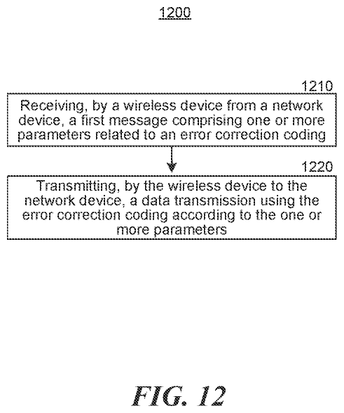

1. A method performed by a wireless device (e.g., method 1200 shown in FIG. 12), comprising: receiving (1210), by a wireless device from a network device, a first message comprising one or more parameters related to an error correction coding; and transmitting (1220), by the wireless device to the network device, a data transmission using the error correction coding according to the one or more parameters.

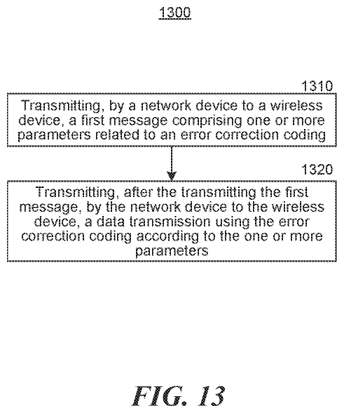

2. A method performed by a wireless device (e.g., method 1300 shown in FIG. 13), comprising: transmitting (1310), by a network device to a wireless device, a first message comprising one or more parameters related to an error correction coding; and transmitting (1320), after the transmitting the first message, by the network device to the wireless device, a data transmission using the error correction coding according to the one or more parameters.

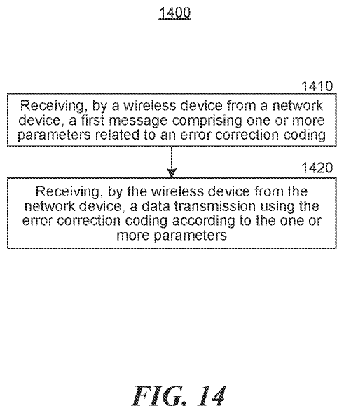

3. A method performed by a wireless device (e.g., method 1400 shown in FIG. 14), comprising: receiving (1410), by a wireless device from a network device, a first message comprising one or more parameters related to an error correction coding; and receiving (1420), by the wireless device from the network device, a data transmission using the error correction coding according to the one or more parameters.

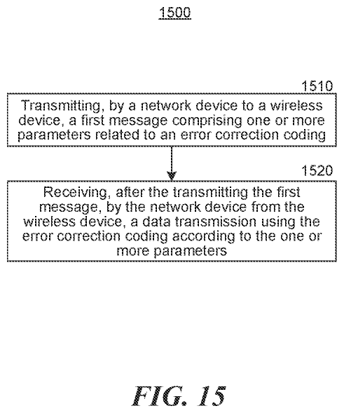

4. A method performed by a wireless device (e.g., method 1500 shown in FIG. 15), comprising: transmitting (1510), by a network device to a wireless device, a first message comprising one or more parameters related to an error correction coding; and receiving (1520), after the transmitting the first message, by the network device from the wireless device, a data transmission using the error correction coding according to the one or more parameters.

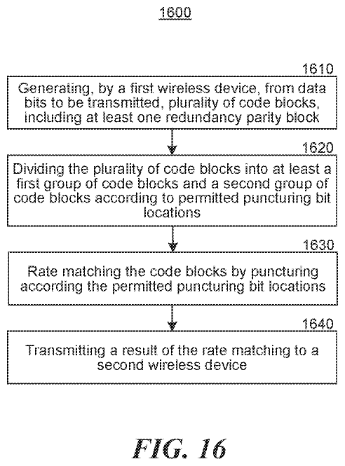

5. A wireless communication method (e.g., method 1600 shown in FIG. 16), comprising: generating (1610), by a first wireless device, from data bits to be transmitted, plurality of code blocks, including at least one redundancy parity block; dividing (1620) the plurality of code blocks into at least a first group of code blocks and a second group of code blocks according to permitted puncturing bit locations; rate matching (1630) the code blocks by puncturing according the permitted puncturing bit locations; and transmitting (1640) a result of the rate matching to a second wireless device.

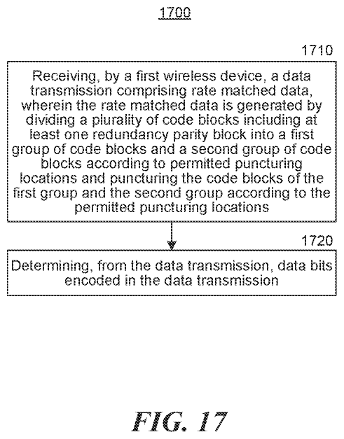

6. A wireless communication method (e.g., method 1700 shown in FIG. 17), comprising: receiving (1740), by a first wireless device, a data transmission comprising rate matched data, wherein the rate matched data is generated by dividing a plurality of code blocks including at least one redundancy parity block into a first group of code blocks and a second group of code blocks according to permitted puncturing locations and puncturing the code blocks of the first group and the second group according to the permitted puncturing locations; and determining (1720), from the data transmission, data bits encoded in the data transmission.

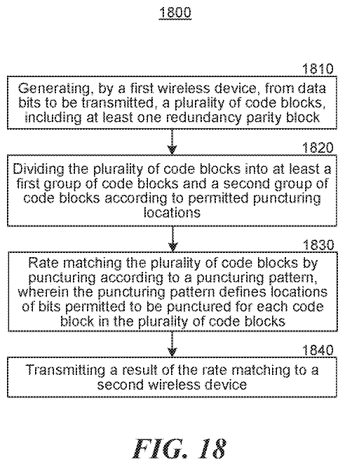

7. A wireless communication method (e.g., method 1800 shown in FIG. 18), comprising: generating (1810), by a first wireless device, from data bits to be transmitted, a plurality of code blocks, including at least one redundancy parity block; dividing (1820) the plurality of code blocks into at least a first group of code blocks and a second group of code blocks according to permitted puncturing locations; rate matching (1830) the plurality of code blocks by puncturing according to a puncturing pattern, wherein the puncturing pattern defines locations of bits permitted to be punctured for each code block in the plurality of code blocks; and transmitting (1840) a result of the rate matching to a second wireless device.

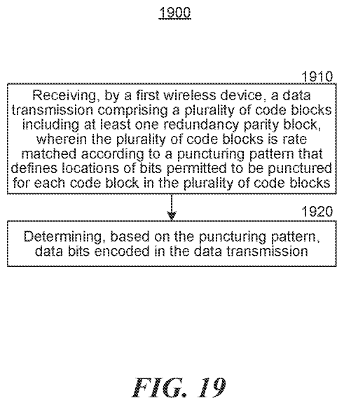

8. A wireless communication method (e.g., method 1900 shown in FIG. 19), comprising: receiving (1910), by a first wireless device, a data transmission comprising a plurality of code blocks including at least one redundancy parity block, wherein the plurality of code blocks is rate matched according to a puncturing pattern that defines locations of bits permitted to be punctured for each code block in the plurality of code blocks; and determining (1920), based on the puncturing pattern, data bits encoded in the data transmission.

9. The method of any of solutions 1-4, wherein the first message is a radio resource control (RRC) signaling, wherein the plurality of parameters of the first message is related to a redundancy parity block transmission.

10. The method of any of solutions 1-4 or 9, wherein the first message is transmitted as a downlink control information (DCI) having a pre-defined format type.

11. The method of any of solutions 1-4, 9 or 10, wherein the data transmission includes a redundancy parity block transmission.

12. The method of any of solutions 1-4 or 9-11, wherein a redundancy parity block included in the data transmission does not include information bits of a transport block and is obtained by at least a plurality of code blocks of the transport block and a generation sequence.

13. The method of any of solutions 1-4 or 9-12, wherein a cyclic redundancy check (CRC) of the first message is scrambled by a specific radio network identifier (RNTI).

14. The method of any of solutions 1-12, wherein the DCI includes a plurality of fields configurable to indicate at least one of the following parameters:

an identifier for a redundancy parity block transmission;

a number of the plurality of code blocks related to the redundancy parity block transmission;

a generation sequence for the redundancy parity block transmission;

a number of redundancy parity blocks;

an index of code blocks related to the redundancy parity blocks;

a rate matching bit pattern;

a HARQ processor number; or

a bitmap of the code block groups,

wherein the generation sequence is used to generate the redundancy parity blocks, and

wherein the rate matching bit pattern is used to determine a puncturing bit location of the plurality of code blocks for the data transmission.

15. The method of solution 14, wherein the generation sequence is determinable from at least one of the number of the plurality of code blocks related to the redundancy parity block and the number of code block groups for the transport block.

16. The method of solution 14, wherein the rate matching bit pattern includes a number of puncturing bits or a corresponding puncturing bit location of the plurality of code blocks for the data transmission.

17. The method of any of solutions 1-12 or 14, wherein the one or more fields in the DCI is configured according to a high layer parameter that configures the redundancy parity block transmission.

18. The method of any of solutions 1-12 or 14, wherein the one or more fields in the DCI is configured based on a high layer parameter reported by the wireless device indicating that the wireless device is able to perform the redundancy parity block transmission.

19. The method of solution 14, wherein the generation sequence is indicated as an index of a list of which the generation sequence is from.

20. The method of solution 19, wherein the generation sequence is from a list that is configured by a high layer parameter.

21. The method of solution 14, wherein the number of the plurality of code blocks related to the redundancy parity block is indicated as a bitmap of a total number of the plurality of code blocks of the transport block.

22. The method of solution 14, wherein a bit width of the redundancy version is smaller than 2.

23. The method of any of solutions 1-12 or 14, wherein the DCI format is at least one of the following:

DCI format 0-1;

DCI format 1-1;

DCI format 0-2;

DCI format 1-2; or

a specific DCI format.

24. The method of any of solutions 14 or 23, wherein at least one of a first type of field in the DCI format 0-1, DCI format 1-1, DCI format 0-2, DCI format 1-2, or a specific DCI format is interpreted as indicating information related to the redundancy parity block transmission if at least one of a second type of fields of the DCI is set to a predefined value.

25. The method of solution 24, wherein the first type of field includes at least one of the following:

a carrier indicator;

a bandwidth part indicator;

a frequency domain resource assignment;

a time domain resource assignment;

a rate matching indicator;

a HARQ process number;

a downlink assignment index;

antenna port(s);

a first downlink assignment index;

a second downlink assignment index for DCI format 0-1;

a ChannelAccess-CPext for DCI format 0-1 or DCI format 1-1;

a transmission configuration indication;

a CBG transmission information (CBGTI);

a CBG flushing out information (CBGFI) of DCI format 1-1;

a modulation and coding scheme;

a new data indicator; or

a redundancy version for transport block 1 of DCI format 1-1.

26. The method of solution 24, wherein the second type of fields in the DCI format 0-1, DCI format 1-1, DCI format 0-2, DCI format 1-2, or a specific DCI format includes at least one of the following:

a frequency domain resource assignment;

a redundancy version;

a UL-SCH indicator;

a CSI request;

a modulation and coding scheme;

a new data indicator;

a redundancy version;

a modulation and coding scheme for a transport block 2 in DCI format 1-1;

a new data indicator for the transport block 2 in DCI format 1-1; or

a redundancy version for the transport block 2 in DCI format 1-1.

27. The method of any of solutions 24 or 26, wherein the second type of fields are used to identify the transmission type of the redundancy parity block transmission.

28. The method of solution 27, wherein the transmission type of the redundancy parity block transmission is determined by at least one of the following:

a number of scheduled redundancy parity blocks; or

times of the scheduled data transmission for the transport block.

29. The method of solution 14, wherein a number of the puncturing bits of each one of the plurality of code blocks for the transport block is not more than a number of the puncturing bits of the redundancy parity block.

30. The method of any of solutions 1-12 or 14, wherein the redundancy parity block included in the data transmission is scheduled based on at least one of the following quantities reported by the wireless device in a value range:

the number of the plurality of code blocks of the transport block;

the number of the plurality of code blocks of the transport block that is not received successfully by the wireless device;

a maximum number of transmissions for the transport block; or

a value of a most recent L1-SINR reported by the wireless device.

31. The method of solution 30, wherein the value range is configured by a high layer parameter.

32. The method of any of solutions 14 or 23, wherein if there is an initial transmission of the transport block, the plurality of fields related to a redundancy parity code block are not included in the DCI format, and wherein if there is a re-transmission of the transport block, the plurality of fields related to a redundancy parity code block are included in the DCI format.

33. The method of any of solutions 5 or 6, wherein the permitted puncturing locations of the first group of code blocks corresponds to head ends.

34. The method of any of solutions 5 or 6, wherein the permitted puncturing locations of the second group of code blocks corresponds to tail ends.

35. The method of any of solutions 1-12 or 14, wherein the puncturing bit locations of a first type of the plurality of code blocks for the transport block are overlapped and are located at a head of each of the plurality of code blocks, and wherein the puncturing bit locations of a second type of the plurality of code blocks for the transport block are overlapped and are located at a tail of each of the plurality of code blocks.

36. The method of any of solutions 5 or 6, wherein an index of the first type of the plurality of code blocks is an odd number and an index of the second type of the plurality of code blocks is an even number.

37. The method of any of solutions 5 or 6, wherein an index of the first type of the plurality of code blocks is an even number and an index of the second type of the plurality of code blocks is an odd number.

38. The method of any of solutions 7 or 8, wherein the puncturing pattern comprises non-overlapping locations for the plurality of code blocks.

39. The method of any of solutions 1-38, wherein the wireless device is a user equipment (UE).

40. The method of any of solutions 1 to 8, further including receiving an acknowledgement of the data transmission.

41. An apparatus for wireless communication, comprising a memory and a processor, wherein the processor reads code from the memory and implements a method recited in any of solutions 1 to 40.

42. A computer readable program storage medium having code stored thereon, the code, when executed by a processor, causing the processor to implement a method recited in any of solutions 1 to 40.

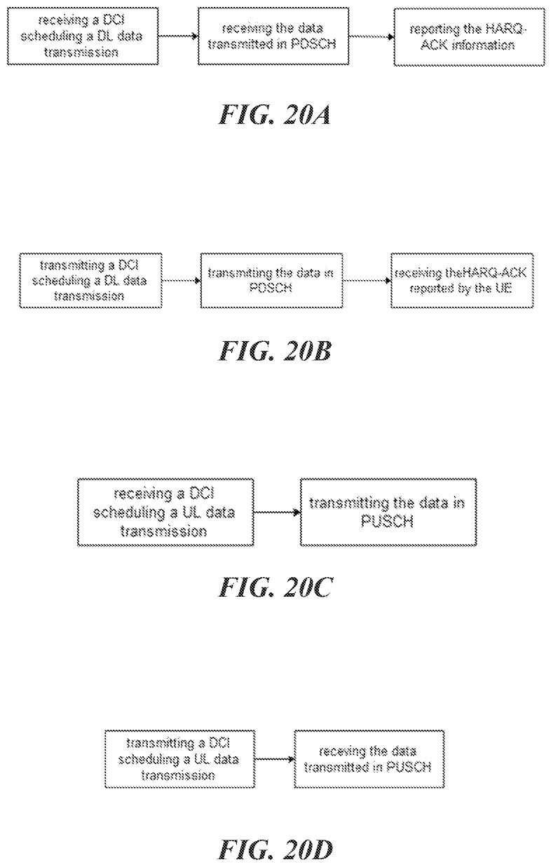

FIGS. 20A and 20B are flow charts for a downlink data transmission scheduling procedure including a redundancy parity block for a wireless device (e.g., a UE) and a network device (e.g., gNB). For example, as described with respect to FIGS. 12-15, and shown in FIG. 20A, in some embodiments, the user device may receive a DCI that schedules a DL data transmission, followed by receiving a data transmission according the schedule received in the DCI on a PDSCH, and subsequently reporting a hybrid automatic repeat request (HARD) acknowledgement for the received data transmission to the network device. Conversely, as described with respect to FIGS. 12-15 and described in FIG. 20B, the network device transmits a DCI that schedules a DL data transmission, following this, the network device transmits data in the PDSCH according to the schedule, and subsequently receives an HARQ-ACK from the receiving wireless device.

FIGS. 20C and 20D are flow charts for an uplink data transmission scheduling procedure including a redundancy parity block for a UE and gNB. For example, as described with respect to FIGS. 12-15, and further shown in FIG. 20C, in some embodiments, a wireless device may receive a DCI that schedules an uplink transmission for the wireless device. The wireless device then subsequently transmits a data transmission of the physical uplink shared channel (PUSCH) according to the schedule.

As described with respect to FIGS. 12-15 and further shown in FIG. 20D, in some embodiments, the gNB may transmit a DCI that provides a schedule for an uplink UL transmission, and subsequently receive a data transmission on the PUSCH according to the schedule.

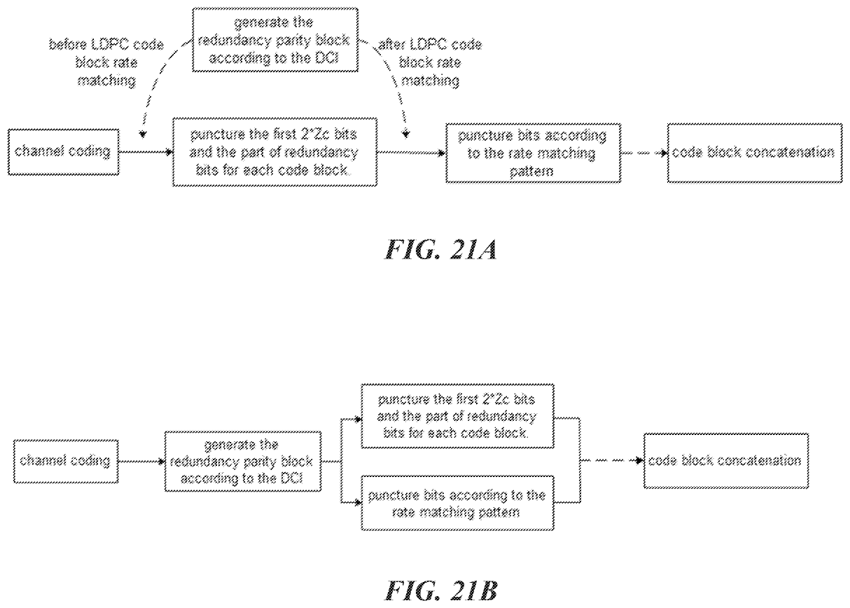

FIGS. 21A and 21B are flow charts of a rate matching for data transmission including a redundancy parity block. For example, in some embodiments, a UE may generate, from data bits to be transmitted, a plurality of code blocks, including a redundancy parity block according to a DCI. The data bits may be punctured according to a rate matching pattern that defines a location of the data bits permitted to be punctured for each code block in the plurality of code blocks.

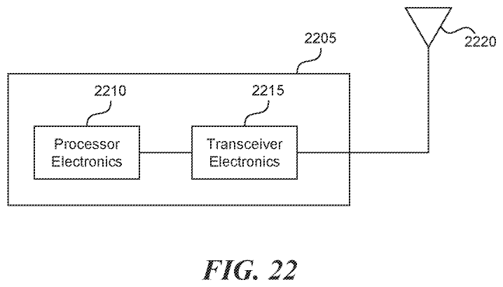

FIG. 22 is a block diagram representation of a portion of an apparatus, in accordance with some embodiments of the presently disclosed technology. An apparatus 2205, such as a base station, a network device, or a wireless device (or UE), can include processor electronics 2210 such as a microprocessor that implements one or more of the techniques presented in this document. The apparatus 2205 can include transceiver electronics 2215 to send and/or receive wireless signals over one or more communication interfaces such as antenna(s) 2220. The apparatus 2205 can include other communication interfaces for transmitting and receiving data. Apparatus 2205 can include one or more memories (not explicitly shown) configured to store information such as data and/or instructions. In some implementations, the processor electronics 2210 can include at least a portion of the transceiver electronics 2215. In some embodiments, at least some of the disclosed techniques, modules or functions are implemented using the apparatus 2205.

Some of the embodiments described herein are described in the general context of methods or processes, which may be implemented in one embodiment by a computer program product, embodied in a computer-readable medium, including computer-executable instructions, such as program code, executed by computers in networked environments. A computer-readable medium may include removable and non-removable storage devices including, but not limited to, Read Only Memory (ROM), Random Access Memory (RAM), compact discs (CDs), digital versatile discs (DVD), etc. Therefore, the computer-readable media can include a non-transitory storage media. Generally, program modules may include routines, programs, objects, components, data structures, etc. that perform particular tasks or implement particular abstract data types. Computer- or processor-executable instructions, associated data structures, and program modules represent examples of program code for executing steps of the methods disclosed herein. The particular sequence of such executable instructions or associated data structures represents examples of corresponding acts for implementing the functions described in such steps or processes.

Some of the disclosed embodiments can be implemented as devices or modules using hardware circuits, software, or combinations thereof. For example, a hardware circuit implementation can include discrete analog and/or digital components that are, for example, integrated as part of a printed circuit board. Alternatively, or additionally, the disclosed components or modules can be implemented as an Application Specific Integrated Circuit (ASIC) and/or as a Field Programmable Gate Array (FPGA) device. Some implementations may additionally or alternatively include a digital signal processor (DSP) that is a specialized microprocessor with an architecture optimized for the operational needs of digital signal processing associated with the disclosed functionalities of this application. Similarly, the various components or sub-components within each module may be implemented in software, hardware or firmware. The connectivity between the modules and/or components within the modules may be provided using any one of the connectivity methods and media that is known in the art, including, but not limited to, communications over the Internet, wired, or wireless networks using the appropriate protocols.

While this document contains many specifics, these should not be construed as limitations on the scope of an invention that is claimed or of what may be claimed, but rather as descriptions of features specific to particular embodiments. Certain features that are described in this document in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or a variation of a sub-combination. Similarly, while operations are depicted in the drawings in a particular order, this should not be understood as requiring that such operations be performed in the particular order shown or in sequential order, or that all illustrated operations be performed, to achieve desirable results.

Only a few implementations and examples are described and other implementations, enhancements and variations can be made based on what is described and illustrated in this disclosure.

1. A method performed by a wireless device, comprising:
communicating, between a wireless device and a network device, a first message comprising one or more parameters related to an error correction coding; and communicating, between the wireless device and the network device, a data transmission using the error correction coding according to the one or more parameters.

2. A wireless communication method, comprising:
generating, by a first wireless device, from data bits to be transmitted, plurality of code blocks, including at least one redundancy parity block;
dividing the plurality of code blocks into at least a first group of code blocks and a second group of code blocks according to permitted puncturing bit locations;
rate matching the code blocks by puncturing according the permitted puncturing bit locations; and
transmitting a result of the rate matching to a second wireless device.

3. (canceled)

4. The method of claim 1, wherein the first message is a radio resource control (RRC) signaling,
wherein a plurality of parameters of the first message is related to a redundancy parity block transmission; or
wherein the first message is transmitted as a downlink control information (DCI) having a pre-defined format type,
wherein a cyclic redundancy check (CRC) of the first message is scrambled by a specific radio network identifier (RNTI).

5. The method of claim 4, wherein the DCI includes a plurality of fields configurable to indicate at least one of:
an identifier for a redundancy parity block transmission;
a number of plurality of code blocks related to the redundancy parity block transmission;
a generation sequence for the redundancy parity block transmission;
a number of redundancy parity blocks;
an index of code blocks related to the redundancy parity blocks;
a rate matching bit pattern;
a HARQ processor number; or
a bitmap of code block groups,
wherein the generation sequence is used to generate the redundancy parity blocks,
wherein the rate matching bit pattern is used to determine a puncturing bit location of the plurality of code blocks for the data transmission, and
wherein the at least one redundancy parity block does not include information bits of a transport block and is obtained by at least a plurality of code blocks of the transport block and a generation sequence.

6. The method of claim 5, wherein the generation sequence is determinable from at least one of 1) number of the plurality of code blocks related to the redundancy parity block, or 2) number of code block groups for the transport block, wherein the rate matching bit pattern includes a number of puncturing bits or a corresponding puncturing bit location of the plurality of code blocks for the data transmission.

7. The method of claim 5, wherein one or more fields in the DCI is configured according to a high layer parameter that configures the redundancy parity block transmission, and/or wherein a higher layer parameter is reported by the wireless device indicating that the wireless device is able to perform the redundancy parity block transmission.

8. The method of claim 5, wherein the generation sequence is indicated as an index of a list of which the generation sequence is from.

9. The method of claim 5, wherein the number of the plurality of code blocks related to the redundancy parity block is indicated as a bitmap of a total number of the plurality of code blocks of the transport block.

10. The method of claim 4, wherein the DCI format is at least one of:
DCI format 0-1;
DCI format 1-1;
DCI format 0-2;
DCI format 1-2; or
a specific DCI format,
wherein at least one of a first type of field in the DCI format 0-1, DCI format 1-1, DCI format 0-2, DCI format 1-2, or a specific DCI format is interpreted as indicating information related to the redundancy parity block transmission if at least one of a second type of fields of the DCI is set to a predefined value.

11. The method of claim 10, wherein the first type of field includes at least one of:
a carrier indicator;
a bandwidth part indicator;
a frequency domain resource assignment;
a time domain resource assignment;
a rate matching indicator;
a HARQ process number;
a downlink assignment index;
antenna port(s);
a first downlink assignment index;
a second downlink assignment index for DCI format 0-1;
a ChannelAccess-CPext for DCI format 0-1 or DCI format 1-1;
a transmission configuration indication;
a CBG transmission information (CBGTI);
a CBG flushing out information (CBGFI) of DCI format 1-1;
a modulation and coding scheme;
a new data indicator; or
a redundancy version for transport block 1 of DCI format 1-1; and
wherein the second type of fields in the DCI format 0-1, DCI format 1-1, DCI format 0-2, DCI format 1-2, or a specific DCI format includes at least one of:
a frequency domain resource assignment;
a redundancy version;
a UL-SCH indicator;
a CSI request;
a modulation and coding scheme;
a new data indicator;
a redundancy version;
a modulation and coding scheme for a transport block 2 in DCI format 1-1;
a new data indicator for the transport block 2 in DCI format 1-1; or
a redundancy version for the transport block 2 in DCI format 1-1.

12. (canceled)

13. The method of claim 10, wherein the second type of fields are used to identify the transmission type of the redundancy parity block transmission, wherein the transmission type of the redundancy parity block transmission is determined by at least one of: a number of scheduled redundancy parity blocks; or times of a scheduled data transmission for the transport block.

14. The method of claim 5, wherein a number of the puncturing bits of each one of the plurality of code blocks for the transport block is not more than a number of the puncturing bits of the redundancy parity block.

15. The method of claim 4, wherein the redundancy parity block included in the data transmission is scheduled based on at least one of following quantities reported by the wireless device in a value range:
number of the plurality of code blocks of the transport block;
number of the plurality of code blocks of the transport block that is not received successfully by the wireless device;
a maximum number of transmissions for the transport block; or
a value of a most recent L1-SINR reported by the wireless device, wherein the value range is configured by a high layer parameter.

16. The method of claim 5, wherein if there is an initial transmission of the transport block, the plurality of fields related to a redundancy parity code block are not included in the DCI format, and wherein if there is a re-transmission of the transport block, the plurality of fields related to a redundancy parity code block are included in the DCI format.

17. The method of claim 2, wherein the permitted puncturing locations of the first group of code blocks corresponds to head ends, or wherein the permitted puncturing locations of the second group of code blocks corresponds to tail ends.

18. The method of claim 17, wherein the puncturing bit locations of a first type of the plurality of code blocks for a transport block are overlapped and are located at a head of each of the plurality of code blocks, and wherein the puncturing bit locations of a second type of the plurality of code blocks for the transport block are overlapped and are located at a tail of each of the plurality of code blocks; or wherein the permitted puncturing locations of each of a plurality of code blocks are not overlapped.

19. The method of claim 2, wherein
an index of a first type of the plurality of code blocks is an odd number and an index of a second type of the plurality of code blocks is an even number; or
the index of the first type of the plurality of code blocks is an even number and the index of the second type of the plurality of code blocks is an odd number.

20. A communication apparatus, comprising a processor configured to:
communicate, between a wireless device and a network device, a first message comprising one or more parameters related to an error correction coding; and communicating, between the wireless device and the network device, a data transmission using the error correction coding according to the one or more parameters.

21. The method of claim 6, wherein the generation sequence is from a list that is configured by a high layer parameter.
